(19) United States
(12) Patent Application Publication
(10) Pub. No.: US 2025/0124323 A1
(43) Pub. Date: Apr. 17, 2025

(54) QUANTUM COMPUTING SYSTEM AND METHOD FOR USE IN INVESTIGATING QUANTUM ELECTRODYNAMIC EFFECTS IN PHYSICAL SYSTEMS

(71) Applicant: Quantinuum Ltd., London (GB)

(72) Inventors: Maria TUDOROVSKAYA, London (GB); David MUÑOZ RAMO, London (GB)

(73) Assignee: Quantinuum Ltd., London (GB)

(21) Appl. No.: 18/913,033

(22) Filed: Oct. 11, 2024

(30) Foreign Application Priority Data
Oct. 11, 2023 (GB) 2315598.9
Mar. 5, 2024 (GB) 2403217.9

(51) Int. Cl. G06N 10/40

(52) U.S. Cl. CPC G06N 10/40

(57) ABSTRACT

A method and quantum computing system are provided for investigating quantum electrodynamic effects in a physical system containing bosonic components and spin components. The method includes defining a Hamiltonian representation of the physical system, wherein the Hamiltonian representation comprises states and operators for the bosonic components and spin components. The physical system comprises a plurality of interconnected cavities in which the bosonic and spin components of the physical system are located. The bosonic and spin components of the physical system interact with one another according to quantum electrodynamics. The bosonic components of the physical system are able to hop between the interconnected cavities. The states and operators from the Hamiltonian representation of the physical system are mapped onto a quantum circuit for execution on the quantum computing system. The quantum circuit is executed on qubits of the quantum computing system to track the behaviour with time of the physical system.

### CROSS-REFERENCE TO RELATED APPLICATIONS

This application claims priority under 35 U.S.C. § 119 to GB Application No. 2315598.9, filed Oct. 11, 2024, and to GB Application No. 2403217.9, filed Mar. 5, 2024, the entire contents of which are incorporated herein by reference.

### FIELD OF THE INVENTION

This patent application relates to quantum computing systems and methods for use in investigating quantum electrodynamic effects in physical systems.

### BACKGROUND

Quantum computers are inherently suitable for determining properties of complex physical systems, such as modelling the energy states of molecules, because they exploit quantum phenomena. In contrast with classical digital computers in which the basic unit of computation, the bit, has one of two discrete binary states (1 or 0), quantum computers utilise qubits which may exist in a superposition of many different computational states. This allows a quantum computer to investigate many different states in parallel and so provides better scaling for addressing complex problems which may not be accessible via classical computing.

A quantum computer generally supports a fixed number (set) of qubits, for example, 4, 8 or 16, which may be configured into one or more registers. Operations, implemented as gates, may be performed on the set of qubits. These gates are usually provided as one-qubit gates or two-qubit (entangling) gates according to the number of inputs to and outputs from the gate (quantum gates have the same number of outputs as inputs). The gates determine how the quantum computer manipulates the qubits of the quantum computer; these gates generally represent low-level operations to be performed by the hardware (rather than being hardware devices themselves).

Each set of operations which is performed in parallel across the set of qubits is referred to as a slice or layer—this can be considered as representing one step or iteration of processing. An overall computation is usually made up of multiple such slices. The number of slices required for the computation is referred to as the depth of the computation; this is a key factor in the length of time (duration) needed to perform a quantum computation.

Existing quantum computers are generally vulnerable to noise, which can lead to decoherence between the different quantum states. This noise problem becomes more significant as the number of qubits increases for more complex computational processing. Accordingly, work is ongoing to reduce or mitigate the problem of noise in quantum computers.

In recent years, the quantum computing community has also focused on developing efficient algorithms to allow the study of energetics and dynamics of different physical systems, such as molecules or solids, which can be described by spin Hamiltonians. A wide array of software is being developed to investigate such systems while aiming to minimize hardware requirements, such as the number of qubits and circuit depth.

Studies of effects occurring in mixed systems involving both bosons and spin particles have been performed using classical simulations and/or quantum simulations. Note that a quantum simulation may be implemented on a classical computer using a quantum computer emulator (this approach is useful for providing computing resources for developing and implementing quantum programs, simulations, and so on).

Systems with strong field-matter coupling [1] and phase transitions [2] are actively studied by the cavity quantum electrodynamics (cavity QED) community. An example of a mixed system relevant for quantum chemistry comprises molecular vibrations and molecules coupled to an electric field [3]. A number of studies dedicated to simulating systems involving bosons have been carried out in recent years. Open quantum systems with Markovian and non-Markovian dynamics are considered in [4, 5]. Reference [6] introduces a variational basis state encoding algorithm for electron-phonon systems. Qudit quantum operators are considered in [7]. A variational quantum algorithm for computing vibrational states on a molecule is presented in [8]. Dynamics on near-term quantum hardware for first-quantized systems is analyzed in [9] while [10] considers mapping bosons to fermions and then to qubits. An overview for near- and long-term approaches to bosonic systems, specifically in the field of vibrational spectroscopy, is given in [11]. The performance of dynamical simulations is discussed in [12-14].

The present application seeks to further develop quantum computing systems for use in investigating quantum electrodynamic effects in physical systems.

### SUMMARY

The disclosed technology comprises various aspects and embodiments. The invention is defined in the appended claims.

A first aspect of the disclosed technology comprises a method for investigating quantum electrodynamic effects in a physical system containing bosonic components and spin components using a quantum computing system, the method comprising:
defining a Hamiltonian representation of the physical system, wherein the Hamiltonian representation comprises states and operators for the bosonic components and spin components, wherein the physical system comprises a plurality of interconnected cavities in which the bosonic and spin components of the physical system are located, wherein the bosonic and spin components of the physical system interact with one another according to quantum electrodynamics, and wherein the bosonic components of the physical system are able to hop between the interconnected cavities;
mapping the states and operators from the Hamiltonian representation of the physical system onto a quantum circuit for execution on the quantum computing system; and
executing the quantum circuit on qubits of the quantum computing system to track the behaviour with time of the physical system.

In some embodiments, the disclosed technology provides a mapping for a Hamiltonian of a mixed-spin physical system comprising states and operators for bosonic and other spin components of the physical system, in which the bosonic operators are transformed to higher-spin operators which are then used to prepare and compile a quantum circuit which simulates the QED effects of the physical system when executed on a quantum circuit. The transformation used may comprise an inverse Holstein-Primakoff transformation which results in a quantum circuit that may require fewer qubits for reliable measurements of the observables generated when executing the quantum circuit on quantum hardware. By reducing the circuit depth in some embodiments, the disclosed technology may also reduce the overall time required to obtain useful measurements. This may in turn increase the availability of quantum computing for performing such simulations by speeding up throughput of quantum computers which are used as a quantum processing resource in quantum computing cloud services.

The disclosed technology may be used to simulate behaviour of a physical system comprising bosonic and spin components located in cavities where the bosonic components undergo QED interactions with the spin components and are able to hop between cavities. This allows a behaviour of the quantum system to be tracked with time via the simulation, such as determining whether and when the physical system undergoes a phase transition between a Mott insulator and a superfluid.

In some embodiments, the spin components represent two-level systems.

In some embodiments, the physics of the physical system is described by a Hubbard-Jaynes-Cummings (HJC) Hamiltonian.

In some embodiments, mapping the states onto the qubits is performed by direct one-to-one mapping or by binary mapping.

In some embodiments, the states for the bosonic components are mapped to a first set of qubits and the states for the spin components are mapped to a second set of qubits distinct from the first set of qubits.

In some embodiments, the operators for the bosonic components are subject to an inverse Holstein-Primakoff transformation to map the bosonic operators into higher-spin operators which map to the multiphoton regime.

In some embodiments, the inverse Holstein-Primakoff transformation comprises: (i) expressing the boson operators in terms of higher-spin operators, and (ii) mapping higher-spin operators to the quantum computer.

In some embodiments, the spin operators have a spin of ½+n, where n is an integer of 1 or more to accommodate the number of excitations of the bosonic operators converted into spin operators.

In some embodiments, mapping the inverse square root operator is performed using a Newton expansion.

In some embodiments, investigating quantum electrodynamic effects comprises tracking the behaviour with time of the complex physical system to determine whether and when a quantum phase transition occurs.

In some embodiments, the quantum phase transition within the complex physical system corresponds to a transition from a Mott insulator to a superfluid.

In some embodiments, the method further comprises using an overlap parameter to measure the overlap between an initial state and a time-propagated wave function, whereby a phase transition causes the overlap parameter to indicate a minimum overlap.

In some embodiments, the method further comprises using an order parameter to measure the mean variance over time of a polaritonic excitation number, wherein the phase transition separates two regions in which the order parameter plateaus.

In some embodiments, a cavity has an initial state comprising a linear combination of Fock states, wherein only one type of excitation is allowed for a Fock state, such that either a spin component in the excited state or a bosonic component is present.

In some embodiments, a full initial state is constructed as a tensor product of L individual cavity states, where L is the number of cavities.

In some embodiments, the initial state is provided by a particle-preserving ansatz which can be implemented using a quantum circuit of the quantum computing system.

In some embodiments, the quantum computing system comprises a native quantum computer. Other embodiments use a quantum computing system which is a hybrid combination of quantum and classical computers. It is also possible for quantum computing simulations to be performed on high-performance classical computers, as an emulation of a quantum computer.

In some embodiments, the method of the first aspect comprises tracking over time quantum electrodynamic, QED, effects in a physical system containing bosonic components and other spin components using a quantum computing system, and the method comprises:
defining a Hamiltonian representation of the physical system, where the Hamiltonian representation comprises states and operators for the bosonic components and other spin components of the physical system, where the physical system comprises a plurality of cavities in which the bosonic and other spin components of the physical system are located, where the bosonic and other spin components of the physical system interact with one another according to quantum electrodynamics, and where the bosonic components of the physical system are able to hop between cavities;
mapping the states and operators from the Hamiltonian representation of the physical system to prepare a quantum circuit that simulates the physical system, and compiling the quantum circuit for execution on the quantum computing system;
executing the quantum circuit using hardware, for example one or more registers or sets of qubits, qutrits, or qudits, of the quantum computing system to measure observables; and
using the measured observables to track a QED behaviour over time of the physical system.

In some embodiments, the hardware comprises qubits.

In some embodiments, the operators for the bosonic components are expressed as higher-spin operators and wherein the mapping maps the higher-spin operators for the bosonic components and the spin operators for the other spin components of the physical system to the quantum circuit of the quantum computing system.

In some embodiments, the method further comprises obtaining higher-order operators for the bosonic components by subjecting bosonic operators in the Hamiltonian to a transformation.

In some embodiments, the transformation comprises an inverse Holstein-Primakoff transformation.

In some embodiments, the physical system comprises a multiphoton regime and the operators for the bosonic components in the Hamiltonian are transformed using the inverse Holstein-Primakoff transformation into higher-spin operators which are mapped with the spin operators for the other spin components to a quantum circuit for simulating the multiphoton regime when executed on the quantum computer.

In some embodiments, the method comprises compiling the quantum circuit by expressing the bosonic components of the Hamilton as higher-order spin operators using an inverse Holstein-Primakoff transformation;
finding qubit representations separately for an inverse square root operator and spin ladder operators of the Hamiltonian;
exponentiating, the qubit representations for the operators using the operator Trotter-Suzuki decomposition; and
optimizing the quantum circuit for a quantum computing system such as a backend system.

In some embodiments, the circuit is compiled and optimized using a quantum toolkit software development platform for developing and/or executing gate-level quantum computation, for example a software platform such as TKET.

In some embodiments, the circuit is optimized to reduce the number of CNET gates.

In some embodiments, the quantum computer or simulated quantum computer is provided as a remote quantum computing or simulated quantum computing service.

In some embodiments, the quantum computer or simulated quantum computer has a superconducting architecture or an ion trap architecture or nuclear magnetic resonance architecture.

In some embodiments, the quantum computer comprises a quantum hardware architecture comprising hardware qubits, qutrits or qudits.

In some embodiments, the method is implemented using a hybrid quantum computer system where quantum computer hardware is made available for executing a quantum circuit compiled on a classical computer system as a cloud-based quantum computing service.

In some embodiments, the physical system comprises one or more atoms or molecules located in the cavities which are described by spin operators.

In some embodiments, a classical computer system is used to prepare and compile the quantum circuit for execution by the quantum computing system by performing:
defining the Hamiltonian representation of the physical system; and
mapping the states and operators from the Hamiltonian representation of the physical system to compile the quantum circuit simulating the physical system; and
wherein the method further comprises the classical computer causing the quantum computer system to:
   load the compiled quantum circuit on the quantum computer hardware;
   execute the quantum circuit to measure the observables; and
   provide the measured observables to the or another classical computer system for tracking the QED behaviour over time of the physical system.

In some embodiments, the compiled quantum circuit comprises initial states for the bosonic and other spin operators of the physical system and an evolution operator for the initial states derived from the Hamiltonian and one or more measurement circuits for measuring observables as the quantum circuit is executed on the hardware of the quantum computing system.

In some embodiments, the mapping is dependent on the number of bosonic excitations of the physical system represented in the Hamiltonian and whether the hardware of the quantum computer used to execute the quantum circuit has a qubit, qutrit, or qudit architecture.

In some embodiments, wherein the hardware of the quantum computer system comprises at least two registers, each register comprising a set of qubits.

In some embodiments, the hardware of the quantum computer system comprises two registers, and one register comprises a set of two qubits and the other register comprises a set of four qubits.

In some embodiments, the hardware of the quantum computer system comprises two registers, and each register comprises a set of three qubits.

In some embodiments, the states for the bosonic components are mapped to a first set of qubits and the states for the spin components are mapped to a second set of qubits distinct from the first set of qubits.

In some embodiments, as the quantum circuit is executed on hardware of the quantum computer, a measurement of a measurable observable is performed at each time-step up to a characteristic time T=1/J, where J is the value of the hopping strength between cavities of the physical system.

In some embodiments, each measurement of a measurable observable is made at time t=m*dt, where dt is a time interval for each trotter step, and m is the number of trotter steps performed.

In some embodiments, wherein compiling the quantum circuit comprises:
constructing an elementary circuit corresponding to one Trotter step;
appending Nₜᵣₒₜₜₑᵣ*m elementary circuits to one another to form the quantum circuit representing the physical system, where Ntrotter is the number slices in the unitary matrix, V, representing a Trotter-Suzuki decomposition of the exact unitary matrix, U, which represents the evolution operator for the initial states of the Hamiltonian.

In some embodiments, the method further comprises:
optimizing the compiled quantum circuit, by assuming no device constraints and by:
   removing redundancies;
   applying Clifford simplifications;
   commuting single-qubit gates to the front of the circuit, and
   performing one or more compiler passes to balance reducing the Trotter error with increasing Nₜᵣₒₜₜₑᵣ slices whilst minimizing the circuit depth.

In some embodiments, the spin components represent two-level systems.

In some embodiments, the physical system is a physical system, wherein the physics of the physical system describable by a Hubbard-Jaynes-Cummings (HJC) Hamiltonian.

In some embodiments, the Hamiltonian represents other types of bosonic excitations.

In some embodiments, the Hamiltonian represents a physical system comprising electrons in molecules.

In some embodiments, the quantum computer hardware has a qubit architecture and wherein the mapping comprises a direct one-to-one mapping or a binary mapping of the states to qubits.

In some embodiments, the spin operators have a spin of ½+n, where n is an integer of 1 or more to accommodate the number of excitations of the bosonic operators converted into spin operators.

In some embodiments, mapping the inverse square root operator is performed using a Newton expansion.

In some embodiments, tracking the behaviour with time of the physical system comprises determining whether and when QED effects in the physical system represent an occurrence of a quantum phase transition.

In some embodiments, the quantum phase transition within the physical system corresponds to a transition from a Mott insulator to a superfluid.

In some embodiments, a measured observable comprises an overlap parameter.

In some embodiments, the method further comprises: using the overlap parameter to measure the overlap between an initial state and a time-propagated wave function of the Hamiltonian of the physical system, whereby a phase transition causes the overlap parameter to indicate a minimum overlap.

In some embodiments, a measurable observable comprises an order parameter, and the method further comprises using the order parameter to measure the mean variance over time of a polaritonic excitation number, wherein the phase transition separates two regions in which the order parameter plateaus.

In some embodiments, a cavity has an initial state comprising a linear combination of Fock states, wherein only one type of excitation is allowed for a Fock state, such that either a spin component in the excited state or a bosonic component is present.

In some embodiments, the full initial state is constructed as a tensor product of L individual cavity states, where L is the number of cavities.

In some embodiments, the physical system comprises more than two cavities.

In some embodiments, the initial state is provided by a particle-preserving ansatz which is mapped to a quantum circuit of the quantum computing system.

In some embodiments, the quantum computing system comprises a native quantum computer. Other embodiments use a quantum computing system which is a hybrid combination of quantum and classical computers. It is also possible for appropriate quantum computing simulations to be performed on high-performance classical computers, as an emulation of a quantum computer.

In some embodiments, the physical system is initially represented by a wavefunction corresponding to an Mott insulator

In some embodiments, the Hamiltonian represents a phase transition of the physical system to a superfluid, and wherein the measured observables which track over time a QED behaviour of the physical system providing an indication of when the wavefunction corresponds to the physical system being a superfluid.

In some embodiments, the QED behaviour tracked over time of the physical system comprises photon hopping.

In some embodiments, the measured observables represent measurements of at least one of the following:
photon number in each cavity of the physical system;
a plurality of atomic state populations of the physical system;
an energy spectrum of the physical system;
a band structure of the physical system;
an excitation transfer within the physical system; and
measurements of the quantum state entanglement.

In some embodiments, a quantum computing system configured to investigate quantum electrodynamic effects in a physical system containing bosonic components and spin components using a Hamiltonian representation which comprises states and operators for the bosonic components and spin components, wherein the physical system comprises a plurality of cavities in which the bosonic and spin components of the physical system are located, wherein the bosonic and spin components of the physical system interact with one another according to quantum electrodynamics and are able to hop between the cavities; wherein the quantum computing system is configured to:
map the states and operators from the Hamiltonian representation of the physical system to compile a quantum circuit for execution on the quantum computing system; and
   execute the quantum circuit on qubits of the quantum computing system to track the behaviour with time of the physical system.

Some aspects and embodiments of the disclosed technology relate to generating a compiled quantum circuit for execution, for example, on quantum hardware, for tracking a quantum electrodynamic, QED, behaviour of a mixed-spin physical system, wherein the mixed spin physical system comprises bosonic components and other spin components located in a plurality of cavities, wherein the bosonic and spin components experience QED interactions with each other, and wherein bosonic components of the physical system are able to hop between coupled cavities, where the method comprises:
mapping states and general spin operators, S, not limited to spin ½, wherein the general spin operators comprise higher spin operators for the bosonic components and operators for the other spin components of the physical system, to hardware of a quantum computing system to compile the quantum circuit.

Another, second, aspect of the disclosed technology comprises a method for tracking a behaviour with time of a mixed-spin physical system comprising bosonic components and other spin components located in a plurality of cavities, wherein the bosonic and spin components experience QED interactions with each other, and wherein bosonic components of the physical system are able to hop between coupled cavities, the method comprising:
performing a method according to the disclosed technology which generate a compiled quantum circuit for execution, for example, on quantum hardware for tracking a QED behaviour of a mixed-spin physical system; and
causing the quantum circuit to be loaded and executed on hardware of the quantum computing system to obtain measured observables; and
using the measured observables to track the behaviour with time of the physical system.

Another, third, aspect of the disclosed technology, comprises a method for tracking a quantum electrodynamic behaviour in a physical system using a quantum computing system, the method comprising:
compiling, at a classical computer system, a quantum circuit for execution on the quantum computing system by:
   defining a Hamiltonian representation of the physical system, wherein the Hamiltonian representation comprises states and operators for the bosonic components and spin components,
   subjecting the operators for the bosonic components to a transformation to transform the bosonic operators into higher-spin operators which map to the multiphoton regime of the physical system; and
   mapping the states and operators from the Hamiltonian representation of the physical system to hardware of the quantum computing system to compile the quantum circuit for execution on the quantum computing system; and
causing the quantum computing system to:
   load the compiled quantum circuit for execution on hardware of the quantum computing system;
   execute the quantum circuit on the hardware of the quantum computing system;
   and
   obtain measured observables from executing the quantum circuit,
      wherein the method further comprises:
tracking a behaviour with time of the physical system based on the observables measured by the quantum computing system.

In some embodiments, the bosonic components of the physical system are subject to an inverse Holstein-Primakoff transformation to transform map the bosonic operators into higher-spin operators.

In some embodiments, a quantum computer system is configured to measure observables for tracking a behaviour with time of a physical system when executing a quantum circuit compiled by a classical computer system.

According to another, fourth, aspect of the disclosed technology a method performed by a quantum computer system, for example, a quantum computer system configured according to an embodiment of the disclosed technology, provides measurements of observables generated when executing a quantum circuit for tracking a behaviour with time of a physical system, where the method comprises:
loading a complied quantum circuit comprising initial states and an evolution operator for execution on hardware of the quantum computer system;
executing the compiled quantum circuit to measure observables; and
outputting measurements of observables obtained from executing the quantum circuit.

In some embodiments, the quantum circuit is executed multiple times and the output comprises multiple measurements of observables.

In some embodiments, the output is provided to directly or indirectly to a classical computer system on which the quantum circuit was compiled for execution by the quantum computer.

Another, fifth, aspect of the disclosed technology seeks to provide a method for simulating a phase transition in a physical system from a Mott insulator to a superfluid on a quantum computer, the method comprising:
preparing an initial Mott insulator state of the physical system by constructing a linear combination of qubit Fock states for each cavity of a plurality of cavities of the physical system;
encoding a spin-boson Hamiltonian for the physical system using an inverse Holstein-Primakoff transformation;
constructing observables for each cavity of the physical system;
driving time evolution of the wavefunction from the initial Mott insulator state of the physical system by using a first-order Trotter-Suzuki approximation of an evolution operator; and
taking measurements with respect to the phase transition.

In some embodiments of the previous aspect, the quibit Fock states are constructed using a Givens rotations ansatz.

In some embodiments, wherein the observables constructed for each cavity of the physical system comprise:
an overlap squared parameter;
a Lambda-parameter related to the overlap squared parameter,
a polaritonic excitations number operator; and
a variance of the polaritonic excitations number operator.

In some embodiments, the method further comprises using a strong-coupling regime to allow using big Trotter steps such that one time step equals the Trotter step.

In some embodiments, the physical system comprises a plurality of bosonic components and other spin components located in cavities, wherein the bosonic components and other spin components, have quantum electrodynamic interactions with each other and wherein the bosonic components may hop from one coupled cavity to another cavity.

In some embodiments, the physical configuration of the physical system comprises multiple cavities having an identical nature to one another, wherein any measurements of the order parameter are performed for only one of the cavities.

Another, six, aspect of the disclosed technology comprises an apparatus or system configured with means to implement a method for investigating quantum electrodynamic effects in a physical system containing bosonic components and spin components using a quantum computing system according to one of the above aspects or preferred embodiments.

In some embodiments, the apparatus or system comprises:
means for defining a Hamiltonian representation of the physical system, wherein the Hamiltonian representation comprises states and operators for the bosonic components and spin components, wherein the physical system comprises a plurality of interconnected cavities in which the bosonic and spin components of the physical system are located, wherein the bosonic and spin components of the physical system interact with one another according to quantum electrodynamics, and wherein the bosonic components of the physical system are able to hop between the interconnected cavities;
means for mapping the states and operators from the Hamiltonian representation of the physical system onto a quantum circuit for execution on the quantum computing system; and
means for executing the quantum circuit on qubits of the quantum computing system to track the behaviour with time of the physical system.

Another, seventh, aspect of the disclosed technology comprises a non-transient computer program product, wherein the computer program comprises computer code which when loaded from a memory and executed on a classical computer system causes the classical computer system to perform any one of the disclosed methods capable of being performed by a classical computer.

In some embodiments, the computer program product causes a classical computer system to perform a method according to any one of the disclosed for tracking a quantum electrodynamic behaviour in a physical system using a quantum computing system, where the method comprises:
compiling, at the classical computer system, a quantum circuit for execution on the quantum computing system by:
   defining a Hamiltonian representation of the physical system, wherein the Hamiltonian representation comprises states and operators for the bosonic components and spin components,
   subjecting the operators for the bosonic components to a transformation to transform the bosonic operators into higher-spin operators which map to the multiphoton regime of the physical system; and
   mapping the states and operators from the Hamiltonian representation of the physical system to hardware of the quantum computing system to compile the quantum circuit for execution on the quantum computing system; and
causing the quantum computing system to:
   load the compiled quantum circuit for execution on hardware of the quantum computing system;
   execute the quantum circuit on the hardware of the quantum computing system;
   and
   obtain measured observables from executing the quantum circuit, and wherein the method further comprises:
      causing the classical computer or another classical computer to tracking a behaviour with time of the physical system based on the observables measured by the quantum computing system.

Another, eighth, aspect of the disclosed technology comprises a quantum computing system for investigating quantum electrodynamic effects in a physical system containing bosonic components and spin components using a Hamiltonian representation which comprises states and operators for the bosonic components and spin components, wherein the physical system comprises a plurality of interconnected cavities in which the bosonic and spin components of the physical system are located, wherein the bosonic and spin components of the physical system interact with one another according to quantum electrodynamics and are able to hop between the interconnected cavities; the quantum computing system being configured to map the states and operators from the Hamiltonian representation of the physical system onto a quantum circuit for execution on the quantum computing system, and to execute the quantum circuit on qubits of the quantum computing system to track the behaviour with time of the physical system.

Another, ninth, aspect of the disclosed technology comprises a method and quantum computing system for investigating quantum electrodynamic effects in a complex physical system. The method includes defining a representation of the complex physical system, such as a Hamiltonian comprising states and operators for bosonic components and spin components of the system. The complex physical system comprises a plurality of interconnected cavities in which the bosonic and spin components are located. The bosonic and spin components interact with one another according to quantum electrodynamics. The bosonic components are able to hop between the interconnected cavities. The states and operators of the complex physical system are mapped onto a quantum circuit for execution using the qubits of the quantum computing system. Certain operators can be mapped to Pauli gates implementing logical operations that transform the quantum state of a qubit. The quantum computer system is used to track the behaviour with time of the complex physical system.

The aspects and preferred embodiments of the disclosed technology may be combined with each other in any suitable manner as would be readily apparent to someone of ordinary skill in the art.

### BRIEF DESCRIPTION OF THE DRAWINGS

Various implementations of the approach described herein will now be described in detail by way of example with reference to the following drawings:

FIG. 1 is a schematic depiction of two coupled cavities each containing an atom and a mode of the electric field with frequency ω. The hopping strength is denoted by J and the atom-light coupling is g. The energy gap between the ground and the excited state of the atom is ω0.

FIG. 2 shows results for the number of 2-qubit gates in a circuit representation of the interaction term unitary, Eq. 29.

FIGS. 3a and 3b provide schematic diagrams showing an initial state corresponding to the Mott insulator phase. FIG. 3a provides a schematic representation of the initial state construction for one circuit box representing a single cavity. FIG. 3b shows the circuit for the state constructed using the Givens rotations ansatz and decomposed into rotations and Pauli gates. The angle of the rotation gate is a function of the detuning.

FIGS. 4a-4c show results for the overlap parameter obtained using (i) statevectors in FIG. 4a, (ii) the Canonical Swap Test Protocol (CSP) in FIG. 4b, and (iii) Vacuum Test simulations in FIG. 4c. The overlap parameter reflects the phase transition and is related to the overlap between the initial Mott insulator state and the time-evolved wavefunction.

FIGS. 5a and 5b are schematic representations of the overlap measurement protocol, with FIG. 5a relating to the use of CSP and FIG. 5b relating to the use of Vacuum test simulations.

FIGS. 6a-6d depict the order parameter as a function of detuning with FIG. 6a showing a QED classical study, and FIGS. 6b-6d showing results obtained using an example of the approach described herein with different numbers of shots.

FIGS. 7a and 7b are schematic diagrams showing time-dependent variance in the number of excitations. In particular, FIG. 7a shows small detuning, and FIG. 7b shows large detuning.

FIG. 8a shows the number of 2-qubit gates per Trotter step for circuits generated by TKET (without taking an architecture into account). FIG. 8b shows a classical simulation for a given number of cells L and photons and a small (solid line) or large (dashed line) amount of detuning.

FIG. 9 is a schematic diagram illustrating an example of a quantum computational system (environment) such as may be utilized to obtain the results presented herein.

FIG. 10 is a schematic flowchart illustrating an example of a method for use in investigating quantum electrodynamic effects in physical systems.

FIG. 11 is a schematic diagram illustrating an example embodiment of a hybrid quantum computer system configured to implement a method of tracking a behaviour of a physical system according to the disclosed technology.

FIG. 12 is a schematic diagram illustrating an example embodiment of a quantum computing as a service system via which a quantum computer may be configured by a classical computer system to implement a method of tracking a behaviour of a physical system according to the disclosed technology.

FIG. 13 illustrates schematically an example embodiment of a method performed by a classical computer system to track a behaviour of a physical system using the disclosed technology.

FIG. 14 illustrates schematically an example embodiment of a method for providing measurements of observables obtained by executing a quantum circuit for tracking a behaviour with time of a physical system according to the disclosed technology.

FIG. 15 illustrates schematically an example embodiment of a method for simulating a phase transition of a physical system from a Mott insulator to a superfluid on a quantum computer.

### DETAILED DESCRIPTION

### 1) Introduction

The present approach relates to complex physical systems which are mixed in that they include interactions between bosons and matter. Bosons are particles with integer spin, and for present purposes are primarily photons having spin 1; photons provide the quantum force carrier for electromagnetic fields. Please note that the terms ‘boson’ and ‘photon’ are generally used herein in an interchangeable manner. The behaviour of photons is generally described (to great accuracy) by the theory of quantum electrodynamics (QED). However, as is generally the case for most physical theories, purely analytical solutions are rarely available, and hence applications of the theory rely on analytical approximations and/or numerical simulations.

The mixed systems further include spin components which typically relate to matter that is able to transition between pre-defined (e.g. 2) different states. The matter may comprise electrons, protons, neutrons, or at a higher level, atoms. For present purposes, the spin components can be considered as representing matter, while bosons (photons) can be considered as representing the electromagnetic field.

Accordingly, the present approach relates to dynamics driven by a Hamiltonian which includes both bosonic operators and spin operators (the latter represent matter typically which adopts and transitions between two different states). This work addresses, inter alia, the problem of efficiently mapping the bosonic particles onto quantum circuits. This work further supports modeling various additional systems, including time-dependent collective effects for such systems.

We first consider a Hamiltonian for a system involving different kinds of particles. Such a Hamiltonian typically contains terms that count the number of particles (or excitations) for each category of particles and an interaction term that mixes operators of different types. Thus a Hamiltonian which mixes both spin particles and boson particles may be written as:

$${H}^{mixed} ≡ {H}_{s p i n} + {H}_{b o s o n} + {H}_{i n t e r a c t i o n} \qquad ( 1 )$$

An example of such a system is the Rabi Hamiltonian for an atom interacting with an AC (alternating current) electric field. In this example, the atom is taken to be a two-level system which is represented by spin operators, and the field is quantized and described by boson operators:

$${H}^{R a b i} = ω {b}^{†} b + \frac{{ω}_{0}}{4} {σ}_{+} {σ}_{-} + g {σ}_{x} ( b + {b}^{†} ) \qquad ( 2 )$$

where b^{†}, b are bosonic creation/annihilation operators, and σ_{±}=σₓ±iσ_{y} are ladder operators. Note the absence of the factor ½ in this definition. For spin ½, the spin operator is

$${S}^{( 1 / 2 )} = \frac{1}{2} σ \qquad ( 3 )$$

and the elements of the σ vector are the Pauli matrices σₓ, σ_{y}, σ_{z}:

$$\begin{matrix}{b}_{x} = ‖ \begin{matrix}0 & 1 \\ 1 & 0\end{matrix} ‖ , & {b}_{y} = ‖ \begin{matrix}0 & - i \\ i & 0\end{matrix} ‖ , & {b}_{z} = ‖ \begin{matrix}1 & 0 \\ 0 & - 1\end{matrix} ‖\end{matrix} \qquad ( 4 )$$

Here, ω, ω₀ are the field frequency and the energy difference between the ground and excited states of the atom and g is the interaction strength.

Assuming the frequencies are nearly in resonance, |ω−ω₀|<<ω, the rotating wave approximation, where the counter-rotating terms are neglected, is applied and leads to the so-called Jaynes-Cummings (JC) Hamiltonian:

$${H}^{JC} = ω {b}^{†} b + \frac{{ω}_{0}}{4} {σ}_{+} {σ}_{-} + \frac{g}{2} ( {σ}_{+} b + {σ}_{-} {b}^{†} ) \qquad ( 5 )$$

Note that although an example implementation is described herein based on the Jaynes-Cummings Hamiltonian, it will be appreciated that the present approach is general and applies to Hamiltonians that include other types of bosonic excitations. Furthermore, this approach can include particles, such as electrons in molecules.

The JC and Rabi Hamiltonians (Eqs. 1, 2, 5) contain both spin and bosonic components, and these components are encoded into the qubit register for simulations on a quantum computer. Several boson mappings are known and used in the literature, and the question of the efficiency of these encoding schemes is important in the context of the overall efficiency of quantum algorithms. In the present approach, spins and bosons are mapped to different parts of the qubit register. This approach builds in part upon a one cavity-one photon system considered in which is based on the Holstein-Primakoff transformation.

In addition to the mapping problem, another important factor is the number of measurements (or shots) required to simulate the physical property of interest on a quantum computer. This factor is particularly prominent in quantum chemistry simulations, where the number of shots required to obtain energies with chemical accuracy may be prohibitive with near-term hardware. However, in the context of cavity QED, interesting phenomena often have a qualitative nature, such as (for example) whether a certain phase transition does or does not occur? The simulation of this type of system on a quantum computer is assumed to utilise a much lower number of shots and hence be viable on existing or near-term quantum computers. This assumption is tested herein using a simulation of a system with multiple cavities and photons.

By way of overview, Section 2 below presents various ways to map bosonic operators which are contained in mixed Hamiltonians, including the Holstein-Primakoff transformation for higher spins. The efficiency of the latter is briefly discussed in relation to other mappings. To provide confirmation of the mapping scheme presented herein, it is tested for a physical problem which is both useful for the real-world applications and also has been well-described classically so that the results can be compared exactly. In addition, reference is made to the TKET compiler as described in [16].

Section 3 then introduces the concept of a phase transition in coupled cavities and explains its significance. The approach described herein is applied to this model. It is shown how to prepare the initial wavefunction to correspond to a Mott insulator and run the dynamics to demonstrate which Hamiltonian parameters support the phase transition, and when the wavefunction of the system indicates it is a superfluid. Simulations of noisy backend emulators are presented in Section 4, and Section 5 presents various conclusions giving an outlook for future improvements.

### 2) Boson Mapping

### 2.1—Some Standard Mapping Schemes

There are various known ways to map bosonic states and operators to qubits [17-19]. Standard mapping schemes include, but are not limited to, direct one-to-one mapping or binary mapping. Within the most straightforward scheme, one-to-one mapping, the size of the Fock space corresponds to the number of qubits available for boson encoding. N+1 qubits can be used to encode N+1 Fock states with up to N bosons. Consider one mode which is denoted as χ, and spins up and down which are denoted as 1 and V, respectively (see details in [19]). The states and the creation operator are mapped as follows:

$${\vert 0 〉}_{χ} ↔ \vert {↑}_{0} {↓}_{1} {↓}_{2} ………… {↓}_{N} 〉 \qquad ( 6 )$$

$${\vert m 〉}_{χ} ↔ \vert {↓}_{0} {↓}_{1} {↓}_{2} … {↑}_{m} … {↓}_{N} 〉 \qquad ( 7 )$$

$${b}_{χ}^{†} = {\sum }_{i} \sqrt{i + 1} {σ}_{-}^{i} {σ}_{+}^{i + 1} \qquad ( 8 )$$

A binary mapping is more efficient in terms of qubit usage, since a binary mapping requires minimum qubits=┌log₂ (N+1)┐ where N is the number of photons (bosonic excitations in the system). To represent a state, it can be viewed as a base-2 number system in which each digit has a position which represents a power of 2. A binary mapping can be implemented as below:

$${\vert 0 〉}_{χ} ↔ \vert {↑}_{1} {↑}_{2} … {↑}_{t - 1} {↑}_{t} 〉 \qquad ( 9 )$$

$${\vert 1 〉}_{χ} ↔ {↑}_{1} {↑}_{2} … {↑}_{t - 1} {↓}_{t} 〉 \qquad ( 10 )$$

$${\vert 2 〉}_{χ} ↔ \vert {↑}_{1} {↑}_{2} … {↓}_{t - 1} {↑}_{t} 〉 \qquad ( 11 )$$

$${\vert 3 〉}_{χ} ↔ \vert {↑}_{1} {↑}_{2} … {↓}_{t - 1} {↓}_{t} 〉 \qquad ( 12 )$$

$${\vert {2}^{t} - 1 〉}_{χ} ↔ \vert {↓}_{1} {↓}_{2} … {↓}_{t - 1} {↓}_{t} 〉 \qquad ( 13 )$$

Note that the register size t≤N.

Once the states are mapped, one can proceed with either deriving the qubit representation of the operators or mapping the entire Hamiltonian onto the circuit. Although matrices describing bosonic operators have infinite dimensions, practical applications require truncation. An N×N matrix can represent boson creation, annihilation, and number operators, as well as the bosonic part of the Hamiltonian operator, for a system of up to N−1 photons. The number operator matrix has numbers from 0 to N−1 on its diagonal. Whether the numbers are ascending or descending is a matter of basis states ordering, but care needs to be taken that the creation and the annihilation operators are constructed consistently.

A variety of approaches are available for circuit mapping of bosonic operators. For example, in [19], the form of the creation operators is derived separately and iteratively for different qubit numbers; this reference further considers the effect of the operator on the qubit register and uses recurrence relations. For 2 qubits:

$${b}_{χ}^{†} = \frac{1}{4} ( I + {σ}_{z} ) ⊗ {σ}_{-} + \frac{\sqrt{2}}{4} {σ}_{-} ⊗ {σ}_{+} + \frac{\sqrt{3}}{4} ( I - {σ}_{z} ) ⊗ {σ}_{-} \qquad ( 14 )$$

where I is a one-qubit identity operator, σ_{±}=σₓ+iσ_{y} (see Eq. 4 for definitions). Note that here σ_{±} differs from the one in by the ½ coefficient, and therefore Eq. 14 also differs from [19]. Its matrix form is:

$${b}_{χ}^{†} = ‖ \begin{matrix}0 & 0 & 0 & 0 \\ 1 & 0 & 0 & 0 \\ 0 & \sqrt{2} & 0 & 0 \\ 0 & 0 & 3 & 0\end{matrix} ‖ . \qquad ( 15 )$$

Other bosonic operators can be derived correspondingly.

As mentioned, another approach to implementing the binary mapping starts with expressing the entire Hamiltonian as a Hermitian 2ⁿ×2ⁿ matrix. The matrix of the evolution operator e^{-iHt} is a unitary that can always be represented as a sequence of Pauli gates. The Hamiltonian itself can be represented as a linear combination of n-fold tensor products of the Pauli matrices. While it can always be done, this approach is relatively inefficient, especially for large number of bosons. The question of what exactly is the most efficient way of representing this matrix on a circuit remains open.

### 2.2-Holstein-Primakoff Inverse Mapping for Multiphoton Regime

As described herein, a physically-motivated mapping scheme has been developed (having regard to the higher spin, multiphoton, Holstein-Primakoff mapping) that allows for treating spin and boson operators on an equal footing. That is, in a mixed spin-boson system, one may choose to express that entire Hamiltonian either with spin operators or with boson operators.

The direct Holstein-Primakoff transformation was introduced to treat high spin operators in ferromagnetic materials and is used to convert spin particle operators in a mixed-particle Hamiltonian H into bosonic ones:

$$\begin{matrix}H ( b , {b}^{†} , {S}_{z , \pm } ) \to H ( b , {b}^{†} , \tilde{b} , {\tilde{b}}^{†} ) & direct\end{matrix} \qquad ( 16 )$$

Here, b^{(†)}, \tilde{b}^{(†)} symbols are for boson operators and S_{z,±}, \tilde{S}_{z,±} symbols are the ladder operators for the general spin operator S not limited to spin ½.

The inverse transformation converts bosonic operators into spin operators which is of interest for the quantum circuit model of quantum computing.

$$\begin{matrix}H ( b , {b}^{†} , {S}_{z , \pm } ) \to H ( {S}_{z , \pm } , {\tilde{S}}_{z , \pm } ) & inverse\end{matrix} \qquad ( 17 )$$

Note that the spin operators may describe high-value spins. Different device architectures may perform differently for the same simulated physical system. Performance also depends on the chosen mapping scheme. For a qubit/qudit architecture, expressing the Hamiltonian with spin operators is a natural choice. Besides physical intuition, the possible advantage of using the spin representation comes from the matrix form of the operators. Both bosonic and spin ladder operators are represented by sub- or superdiagonal matrices. In addition, higher spin matrices possess mirror symmetry relative to the main diagonal. Some studies suggest that such symmetry can lead to circuit depth reduction that includes the block-encoding of the non-unitary operator itself [21], [22]. So far, this inverse mapping which is used herein has received relatively little attention, especially in the context of quantum computing.

Use of the inverse Holstein-Primakoff transformations involves two steps: (i) expressing each bosonic ladder operators in terms of higher-spin operators which can be done exactly or approximately, and (ii) mapping higher-spin operators to the quantum computer. For (ii), there is freedom in how exactly the mapping is performed. This depends on the system's highest spin, which in turn corresponds to the number of bosonic excitations to be represented, and whether a qubit, qutrit, or qudit architecture is used. As far as we are aware, the inverse Holstein-Primakoff mapping for quantum computers has previously only been used for spin ½ (see an example in [15]), and it has not been considered for a broader range of physical multi-photon problems.

The classical problem of “spinorization” of a boson was introduced in [23]. One can write:

$$\begin{matrix}{b}^{†} = {S}_{+} \frac{1}{\sqrt{SI - {S}_{z}}} ; & b = \frac{1}{\sqrt{SI - {S}_{z}}} {S}_{-}\end{matrix} \qquad ( 18 )$$

$${b}^{†} b ≡ SI + {S}_{z} \qquad ( 19 )$$

Here, S is the maximum eigenvalue of S_{z}, I is a multi-qubit identity. Eq. 18, 19 apply to any S. Using the example of S=½, it will be readily appreciated that the number operator has descending integers on the diagonal (this differs from the usual definition). In order to understand why the mapping is always possible, note that in the z-basis, the S_{z} matrix is always diagonal, with the diagonal elements S_{z}^{n,n}=S+1−n. Consequently, the matrix representation of the number operator in Eq. 19 is the same as the one as described in Subsection 2.1 above as set out in the oscillator basis.

The next obstacle to overcome is the question of how to deal with the inverse square root operator. Combining Eq. 18 and Eq. 19:

$$\sqrt{SI - {S}_{z}} = 2 S \sqrt{I - \frac{{b}^{†} b}{2 S}} \qquad ( 20 )$$

In the literature, a Taylor expansion has sometimes been employed for this purpose (see, for example, [15]). For a given function ƒ(b^{†}b), its Taylor series expansion around zero reads:

$$f ( {b}^{†} b ) = {\sum }_{k = 0}^{∞} \frac{1}{k !} {\partial }_{{b}^{†} b}^{k} f ( 0 ) {( {b}^{†} b )}^{k} \qquad ( 21 )$$

Strictly speaking, however, the Taylor expansion is only valid when the function is analytic around the expansion point, which does not hold for the square root function.

Following [24], a Newton expansion is used instead for this purpose. This expansion allows us to represent the square root as a power series of the number operator (up to the power of 2S). Expressing the normalized matrix square-root function, h, in terms of the number operator, from [23]:

$$h ( {b}^{†} b ) = \sqrt{I - \frac{{b}^{†} b}{2 S}} = {\sum }_{k = 0}^{2 S} \frac{{b}^{† k} {b}^{k}}{k !} {\sum }_{l = 0}^{k} {( - 1 )}^{k - l} \sqrt{1 - \frac{l}{2 S}} ( \frac{k}{l} ) \qquad ( 22 )$$

This expansion holds without assuming that (a) the total spin is large, and therefore the series can be truncated, or (b) the small qubit register allows to capture a significant part of the essential physics for spin ½ (as in [15]). The difference from the Taylor series can be seen in the expansion coefficients starting with the power k=1.

For the Newton expansion, h≈1I−b^{†}b, compared with the Taylor expansion: h≈1I−b^{†}b/2. The Newton series has the advantages that (i) it is exact for 2S terms in the expansion and (ii) the square root function is now expressed in terms of the number operator which we know is diagonal. Inverting a diagonal operator or finding powers of a diagonal operator is a routine task. In addition, quantum algorithms for working with diagonal operators are well-known [25].

In a system of interest (as discussed below), the maximum spin corresponds to 2S=3. In this case, we have:

$$h = α I + β {b}^{†} b + {γ ( {b}^{†} b )}^{2} + {δ ( {b}^{†} b )}^{3} , \qquad ( 23 )$$

where α, β, γ are the expansion terms which can be found from Eq. 22. Eq. 23 describes a diagonal matrix, and therefore finding the matrix for h⁻¹ when performing the inverse transformation is straightforward.

### 2.3—Circuit Implementation of the Mapping Corresponding to the Inverse Holstein-Primakoff Transformation for Spin 3/2

We present here an example of the circuits for implementing the approach described herein. We focus on the specific case corresponding to S=3/2, which represents the maximum spin in the system under study that we discuss below.

In this example, following approach is used to map spin 3/2 operators onto qubit Pauli operators (this approach is exact):

$$\begin{matrix}2 {S}_{x} = \sqrt{3} I ⊗ {σ}_{x} + \frac{σ\_ ⊗ {σ}_{+} \pm {σ}_{+} ⊗ σ\_}{2} \\ 2 {S}_{x} = \sqrt{3} I ⊗ {σ}_{x} + {σ}_{x} ⊗ {σ}_{x} + {σ}_{y} ⊗ {σ}_{y}\end{matrix} \qquad ( 24 )$$

$$\begin{matrix}2 {S}_{y} = \sqrt{3} I ⊗ {σ}_{y} - \frac{σ\_ ⊗ {σ}_{+} - {σ}_{+} ⊗ σ\_}{2 i} \\ 2 {S}_{y} = \sqrt{3} I ⊗ {σ}_{y} + {σ}_{y} ⊗ {σ}_{x} - {σ}_{x} ⊗ {σ}_{y}\end{matrix} \qquad ( 25 )$$

$$2 {S}_{z} = \frac{( I + {σ}_{z} ) ⊗ ( I - {σ}_{z} ) - ( I - {σ}_{Z} ) ⊗ ( I + {σ}_{z} )}{4} + 3 \frac{( I + {σ}_{z} ) ⊗ ( I + {σ}_{z} ) - ( I - {σ}_{z} ) ⊗ ( I - {σ}_{z} )}{4} \qquad ( 26 )$$

The ladder operators are S_{±}=Sₓ±iS_{y}, as usual.

Using Eq. 18-Eq. 26, we obtain:

$${b}^{†} = \frac{\sqrt{1}}{4} ( I - {σ}_{z} ) ⊗ {σ}_{+} + \frac{\sqrt{2}}{4} {σ}_{+} ⊗ {σ}_{-} + \frac{\sqrt{3}}{4} ( I + {σ}_{z} ) ⊗ {σ}_{+} \qquad ( 27 )$$

The expression in Eq. 27 can be obtained from Eq. 14 by multiplying with σₓ⊗σₓ both on the left and on the right. The matrix representation of Eq. 27 is

$${b}^{†} = ‖ \begin{matrix}0 & \sqrt{3} & 0 & 0 \\ 0 & 0 & \sqrt{2} & 0 \\ 0 & 0 & 0 & \sqrt{1} \\ 0 & 0 & 0 & 0\end{matrix} ‖ \qquad ( 28 )$$

The difference in the ordering of the elements between Eq. 28 and Eq. 15 corresponds to the different (ascending or descending) order of the matrix elements in the number operator and is a matter of choice. To make our matrix representation of the Hamiltonian exactly match the classical one from [26], we further multiply the Hamiltonian operator on the left and on the right by the string of σₓ operators acting on all qubits. The same effect may also be achieved by altering the meaning of qubits and their states for each cell.

Although Eq. 14 and Eq. 27 are equivalent, we note that the Holstein-Primakoff transformation does not require iterative operator construction. Instead, the circuit mapping of the Holstein-Primakoff transformation relies on the mapping of the higher spin matrices (which are known and standard) and the circuit representation of the diagonal matrices circuit.

### 2.4-Efficiency of the Mapping Scheme

In this section, the efficiency of the mapping scheme for time evolution is assessed. While efficient decomposition techniques for exact unitaries exist, they are normally limited to a small number of qubits making it beneficial to analyze the approximate evolution. Recalling the exponential form of the time evolution operator for the full Hamiltonian of Eq. 1 and applying the Trotter-Suzuki expansion to it:

$${U}_{{H}_{m i x e d}} ( t + d t ) \approx {e}^{- i {H}_{m i x e d} dt} \approx {e}^{- i {H}_{s p i n} dt} {e}^{- {iH}_{b o s o n} dt} {e}^{- {iH}_{i n t e r a c t i o n} dt} \qquad ( 29 )$$

Below, an empirical benchmarking analysis is performed for the exponential operator in Eq. 29, using the example of Eq. 2 to represent the interaction since it contains both spin and boson operators. In this analysis, a minimal example of a multi-boson coupled system is considered, namely, a single atom (spin) interacting with a multi-photon field (i.e. enabling multiple bosonic excitations). First, we look closely at the case with up to 3 photons. After that, we show how it scales with the number of photons.

### 1. Up-to-3 Photons Case

The maximum of 3 photons corresponds to the Holstein-Primakoff mapping with S=3/2 as in Eq. 24-26.

Here, we compare the circuits described in (a) and (b):
(a) a represents an efficient circuit for the exact evolution operator:

$$U = {e}^{- i {H}_{i n t e r a c t i o n} τ} = {e}^{- i g {σ}_{x} ( b + {b}^{†} ) τ} {\vert}_{( τ = 1 , g = 1 )} = {e}^{- i {σ}_{x} ( b + {b}^{†} )} \qquad ( 30 )$$

We begin by obtaining the matrix representation of U, which is derived as the matrix exponential of the tensor product of −iσₓ and b+b^{†}; (b) an approximation, V, mapped to a circuit using the multiphoton Holstein-Primakoff transformation.

(a) Consider the evolution operator in Eq. 30. The spin operator and the boson operators are mapped on separate qubits. Each boson operator is to be eventually expressed in the form of linear combinations of Pauli strings which are not generally commuting, therefore the Trotter-Suzuki decomposition is not exact. The matrix representation of U, in the case of a maximum number of 3 bosons is:

$$U = ‖ \begin{matrix}0.023 & 0. & - 0.714 & 0. & 0. & - 0.632 j & 0. & 0.301 j \\ 0. & - 0.56 & 0. & - 0.412 & - 0.632 j & 0. & - 0.342 j & 0. \\ - 0.714 & 0. & 0.023 & 0 & 0. & - 0.342 j & 0. & - 0.61 j \\ 0. & - 0.412 & 0. & 0.606 & 0.301 j & 0. & - 0.61 j & - 0. \\ 0. & - 0.632 j & 0. & 0.301 j & 0.023 & 0. & - 0.714 & 0. \\ - 0.632 j & 0. & - 0.342 j & 0. & 0. & - 0.56 & 0. & - 0.412 \\ 0. & - 0.342 j & 0. & - 0.61 j & - 0.714 & 0. & 0.023 & 0. \\ 0.301 j & 0. & - 0.61 j & 0. & 0. & - 0.412 & 0. & 0.606\end{matrix} ‖ \qquad ( 31 )$$

The 8×8 matrix of U is mapped to 3 qubits. For 1, 2 and 3-qubit unitaries, TKET [16] can construct optimal (in terms of the CNOT count) circuits relying on the improvement to the Cosine-Sine Decomposition (CSD) [27-29]. For 3 qubits, the TKET method is called “Unitary3qBox”. The Shannon decomposition used in the algorithm builds on the CSD decomposition and also utilises the fundamental and widely-used KAK decomposition [30] introduced by Helgason [31] and implemented by Khaneja and Glaser [32] in one of the steps. The unitary matrix for Eq. 30 is then automatically converted to a 3-qubit circuit box. The circuit is subsequently optimised with the removal of possible redundancies introduced during the initial circuit construction process.

(b) an approximate circuit for the operator U is constructed using the Trotter-Suzuki transformation for Eq. 30. The Trotter-Suzuki decomposition for this Hamiltonian is not exact since σₓb does not commute with σₓb^{†} in the exponential operator in Eq.30. When mapped on a circuit, the argument of the exponential operator will also contain non-commuting Pauli strings. Let V be a unitary corresponding to the Trotter-Suzuki decomposition with Nₜᵣₒₜₜₑᵣ slices:

$$V = {( {e}^{- i \frac{{σ}_{x} b}{{N}_{totter}} {σ}_{x} ( b + {b}^{†} ) / r} {e}^{- i \frac{{σ}_{x} {b}^{†}}{{N}_{totter}}} )}^{{N}_{t r o t t e r}} \qquad ( 32 )$$

choosing Nₜᵣₒₜₜₑᵣ such that the matrix form of V is a good approximation of U.

To map each term in the product, the Holstein-Primakoff encoding was used, as described in sections 2.2. and 2.3. When

$${N}_{trotter} = 10 , \vert \frac{{V}_{i j} - {U}_{i j}}{max {U}_{i j}} \vert = 𝒪 ( 0. 1 ) ,$$

which is an acceptable Trotter error for this study. The resulting matrix is given below in Eq. 33 to be compared to Eq. 31.

$$V = ‖ \begin{matrix}0.021 & 0 & - 0.668 & 0. & 0. & - 0.682 j & 0. & 0.298 j \\ 0. & - 0.556 & 0. & - 0.456 & - 0.581 j & 0. & - 0.382 j & 0. \\ - 0.757 & 0. & 0.023 & 0 & 0. & - 0.3 j & 0. & - 0.58 j \\ 0. & - 0.37 & 0. & 0.606 & 0.298 j & 0. & - 0.638 j & - 0. \\ 0. & - 0.682 j & 0. & 0.298 j & 0.021 & 0. & - 0.668 & 0. \\ - 0.581 j & 0. & - 0.382 j & 0. & 0. & - 0.556 & 0. & - 0.456 \\ 0. & - 0.3 j & 0. & - 0.58 j & - 0.757 & 0. & 0.023 & 0. \\ 0.298 j & 0. & - 0.638 j & 0. & 0. & - 0.37 & 0. & 0.606\end{matrix} ‖ \qquad ( 33 )$$

Circuits representing the unitaries (a) and (b) are compared in terms of the number of native two-qubit operations when compiled with TKET at the highest optimization level. The uncompiled circuit in (b) is significantly longer by construction (since it has appended Nₜᵣₒₜₜₑᵣ copies of the same sub-circuit). The aim is to show that with efficient compilation circuit (b) contains no more 2-qubit gates than circuit (a) while approximating the effect of the same unitary. The optimization leads to removing redundancies, simplifies specific known sequences of Clifford gates, and makes use of circuit decomposition techniques. [16]. The circuit optimization is performed globally for each timestep rather than for each Trotter step. In the last step, the circuits are rewritten in terms of the machine's native gates, where the machine is either IBM's superconducting architecture or an ion trap architecture (Quantinuum H1 device).

| | IBM | H1 |
|---|---|---|
| U (exact, TKET | 24 (CX) | 19 (ZZ-phase) |
| Unitary3qBox) | | |
| V (Trotter, Holstein- | 25 (CX) | 17 (ZZ-phase) |
| Primakoff) | | |

Table 1 above shows how many native 2-qubit gates are contained in circuits (a) and (b) respectively. In particular, Table 1 shows the number of 2-qubit gates for using exact unitary U, Eq. 30, circuit (a) representation, and for using its Trotterized approximation, V, Eq. 32, circuit (b) representation. The circuits are compiled for the corresponding gate-sets native for the architecture, i.e. superconducting (IBM) or trapped ion (H1). The type of the 2-qubit gates is given in brackets. The optimization level in TKET is 2 [16]. One can see that compiling for the H1 device leads to a slightly smaller 2-qubit gate count than compiling for an IBM machine. Moreover, assembling the circuit from individual spin and boson operators mapped using the Holstein-Primakoff transformation with subsequent compilation turns out to be slightly more efficient for the H1 device than mapping the matrix for the exact unitary U directly onto the circuit. It is expected that this would likewise be the case for using a larger number of qubits.

This comparison of the circuits (a) and (b) in Table 1 shows that the Holstein-Primakoff mapping is not only intuitive and physically motivated but also efficient for mixed spin-boson Hamiltonians.

### 2. Higher Number of Photons

Here we consider how the circuit depth for a unitary in Eq. 29 in terms of 2-qubit gates depends on the maximum number of photons allowed in the system. Whether we map the b, b^{†} matrices of bosonic operators (Eq. 28) or use the higher-spin matrices (see Eq. 18, 19), we rely on the expansion as a linear combination of Pauli strings as follows:

$${\sum }_{l} {C}_{l} {P}_{l} = {\sum }_{l} {C}_{l} {\prod }_{κ = 0}^{{κ}_{max}} = {σ}_{{i}_{κ}}^{( {q}_{κ} )} \qquad ( 34 )$$

where Cₗ is the coefficient of the l^{th} Pauli string Pₗ, σᵢ={σₓ,σ_{y},σ₂} determines the kind of Pauli gate, and q is the qubit the corresponding gate acts on.

While different representations can be valid, it is always possible to choose

$${C}_{l} = \frac{1}{4} Tr ( {P}_{l} \cdot U ) .$$

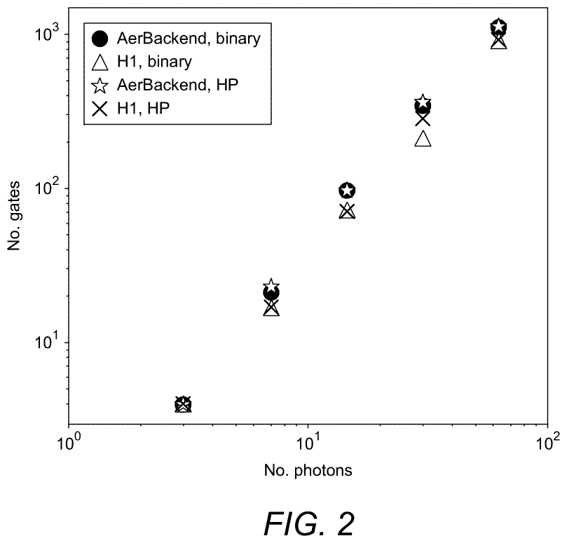

For Holstein-Primakoff mapping, we find the qubit representations for the inverse square root operator and the spin ladder operators separately. Once the qubit representation is found, the operator is exponentiated using the Trotter-Suzuki decomposition, and the resulting circuit is optimized with TKET for the corresponding backend. We look at how deep the circuits are in terms of 2-qubit gates for spin mapping of the Holstein-Primakoff transformation vs. binary mapping of the bosonic operators. The results are shown in FIG. 2.

Upon the optimization, the two approaches lead to closely matching results. The plot exhibits linear dependency. Note that the axes have logarithmic scaling and that the number of qubits required is 2^{┌Log} ^{₂}^{({No.photons}+1)┐}. The Qiskit AerBackend optimization leads to slightly deeper circuits. It should be recognized that the circuit representation of the interaction term and the full evolution operator expressed with either spin or boson operators is not unique. As noted above, matrices of spin operators belong to the SU(2) group and thus possess additional symmetry compared to boson operators. This implies that if a way of taking advantage of this symmetry is found, the efficiency compared to the binary encoding will extend to the multiphoton case.

### 3) Quantum Electrodynamics in Coupled Cavities

In the previous section, a mapping scheme was selected. In this section, the mapping scheme is applied to a real-world problem, both (i) to demonstrate that the approach is correct and can accurately replicate classical results in a statevector simulation, and (ii) to show that QED problems mapped onto quantum circuits with the proposed scheme are suitable for performing a shot-based simulation to extract meaningful results using a reasonable level of hardware resources (such as achievable with existing systems).

An example is provided relating to an insulator-to-superfluid phase transition, which is a many-body quantum phenomenon. In contrast to a classical phase transition, in which a system undergoes a qualitative change in its macroscopic properties, a quantum phase transition is a result of quantum fluctuations. Such a change occurs at a temperature close to absolute zero and can cause a sudden change in the quantum state of the system.

This effect was first proposed for liquid helium [33] and later discovered in other systems such as ultracold gases in optical lattices [34]. Other examples are Josephson junction arrays, and antiferromagnets or frustrated spin systems in the presence of a magnetic field. In the superfluid phase, the particles are unbound and exhibit long-range coherence, losing their individual character. In the Mott insulator phase, in contrast to the superfluid phase, the particles are confined and cannot conduct electricity or move freely.

Rapid progress in cavity and circuit electrodynamics makes it possible to adjust and control the coupling strength between the spin and bosonic particles. Within arrays of coupled cavities, atoms are coupled to a mode of the electric field and photon hopping is allowed between the cavities. Such coupled cavities therefore provide a suitable system to study this type of the phase transition [1, 35]. The phase and intensity of the light can be controlled and physical observables can be measured in different regimes in real time.

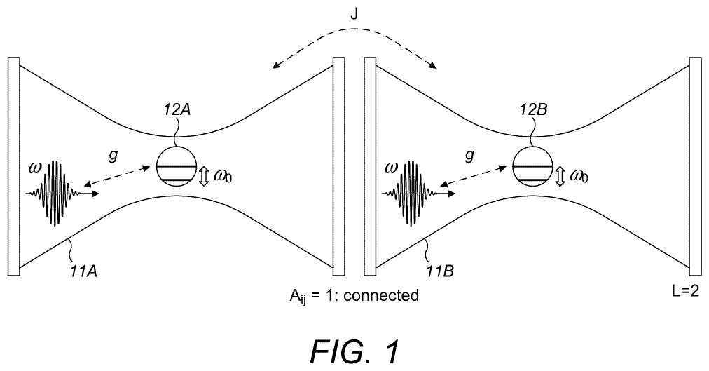

FIG. 1 is a schematic diagram of an example having two coupled cavities which may be subject to an insulator-to-superfluid phase transition [26]. The setup adopted for this example has two coupled cavities as shown schematically in FIG. 1, which allows for observation of the phenomenon of interest [26]. In particular, FIG. 1 provides a schematic depiction of a system 10 comprising the two coupled cavities 11A, 11B (L=2, Aij=1), each cavity containing an atom 12A, 12B and a mode of the electric field with frequency ω. The hopping strength is denoted by J and the atom and the atom-light coupling is g. The energy gap between the ground and the excited state of the atom is ω0.

### 3.1-System Hamiltonian and Parameters

The physics of the system is well-described by the so-called Jaynes-Cummings-Hubbard (JCH) Hamiltonian, where the “Hubbard” part refers to the way the cavities interact, and each cavity is a Jaynes-Cummings system described in Eq. 5. It is also possible to consider the Rabi-Hubbard Hamiltonian. It will be appreciated that the use of the Jaynes-Cummings-Hubbard Hamiltonian is provided by way of example only (without limitation), and other forms of Hamiltonian, such as the Hubbard-Rabi Hamiltonian, might be used instead.

In the rotating wave approximation adopting the Jaynes-Cummings-Hubbard Hamiltonian, the full Hamiltonian reads:

$$\begin{matrix}{H}^{JCH} = {\sum }_{i = 1}^{L} {H}_{i}^{JC} - J {\sum }_{〈 i , j 〉} {A}_{ij} ( {b}_{i}^{†} {b}_{j} + {b}_{i} {b}_{j}^{†} ) \\ = {\sum }_{i = 1}^{L} [ ω {b}_{i}^{†} {b}_{i} + \frac{{ω}_{0}}{4} {σ}_{i , +} {σ}_{i , -} + \frac{g}{2} ( {σ}_{i , +} {b}_{i} + {σ}_{i , -} {b}_{i}^{†} ) ] - \\ J {\sum }_{〈 i , j 〉} {A}_{ij} ( {b}_{i}^{†} {b}_{j} + {b}_{i} {b}_{j}^{†} )\end{matrix} \qquad ( 35 )$$

where the first summation goes over all the cavities, in our case up to L=2. J is the inter-cavity coupling strength and Aij is either 0 or 1 for each cavity pair, depending on whether photon hopping is allowed or not between the cavities with corresponding indices.

TABLE 2

| ω | Δ = ω₀ − ω | g | J |
|---|---|---|---|
| 1 | {10⁻⁵g − 10⁵g} | 0.1 | 0.1 |

Table 2 above lists the parameters used in the simulation, i.e. parameters for the 2 coupled arrays. The values of the parameters are given in atomic units. The characteristic time of the process is T=1/J. For this example, we consider a system where J is large; as a result, the simulation period is shorter. The motivation for this approach is to maintain good accuracy using only a relatively modest number of time steps and Trotter steps. Throughout the study, A was varied to cover both near-resonant ω0−ω≈0 and off-resonant regimes.

For each cavity, 1 qubit is used to represent the atom and 2 additional qubits are used to represent the photons. The maximum number of photons per cavity is determined by the initial conditions. In the setup, it is specified that a cavity cannot accommodate more than 2 photons. However, the use of 2 qubits per cavity potentially allows having to 3 photons per cavity. In general, the number of qubits utilised may allow for a larger number of bosonic states beyond the specificity of the problem setup.

The resulting qubit Hamiltonian as mapped to qubits contains 55 terms of the general form of Eq. 34.

The maximal length of a Pauli string in this example of a qubit Hamiltonian is κₘₐₓ=4.

### 3.2—Initial State Preparation

The initial state, denoted by Ψt=0, corresponds to a pair of identical cavities 11A, 11B each in the Mott insulator state. In each cavity, the state is a linear combination of Fock states and can be represented as |n=1,− [symbol] , with n being the number of photons. Only one type of excitation is allowed in this state, either an atom in the excited state or a photon can be present. The resulting full initial state is constructed as a tensor product of L individual cavity states [1, 26]:

$${{{Ψ}_{t = 0} = \vert n , - 〉}_{0} ⊗ … ⊗ \vert n , - 〉}_{L} \qquad ( 36 )$$

$$and$$

$${\vert n , - 〉}_{i} = cos ( {θ}_{i} ) \vert e 〉 ⊗ \vert n 〉 - sin ( {θ}_{i} ) \vert g 〉 ⊗ \vert n - 1 〉 \qquad ( 37 )$$

In this setup, L=2 and the initial number of photons in a cavity n=1; θi is related to the coupling strength, g, and the detuning parameter, Δ=ω−ω₀, can be written as:

$$tan ( {θ}_{n} ) = 2 g \sqrt{n} / Δ \qquad ( 38 )$$

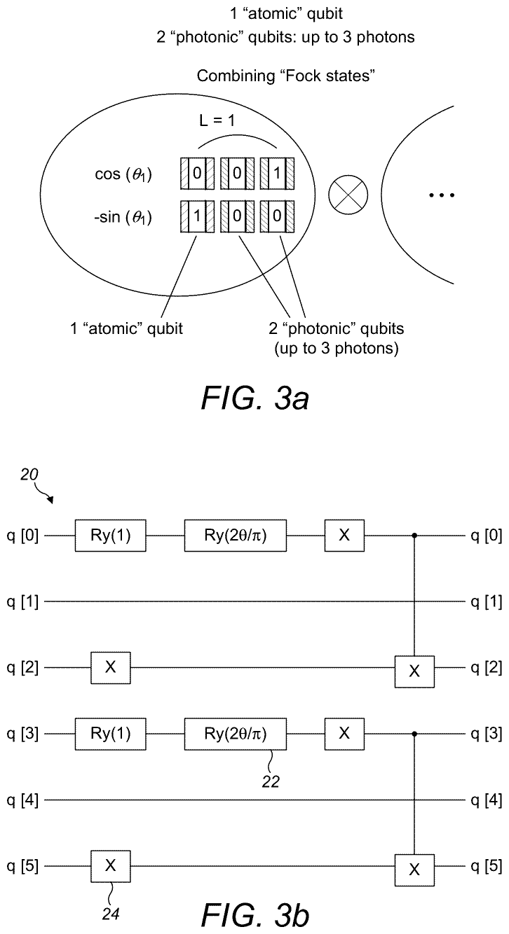

An ansatz (a form of trial solution) is produced which combines the qubit states 100 and 001 (as described below with reference to FIG. 3a).

By way of example, a particle-preserving ansatz may adopted that employs Givens rotations [36]. Controlled Givens rotations are universal for particle-conserving unitaries and therefore allow us to explore the entire Hilbert space. The matrix representation of the Givens rotation by an angle ϕ is:

$$G = ‖ \begin{matrix}1 & … & 0 & … & 0 & … & 0 \\ … & … & … & … & … & … & … \\ 0 & … & c & … & - s & … & 0 \\ … & … & … & … & … & … & … \\ 0 & … & s & … & c & … & 0 \\ … & … & … & … & … & … & … \\ 0 & … & 0 & … & 0 & … & 1\end{matrix} ‖ \qquad ( 39 )$$

where c=cos ϕ and s=sin ϕ.

Givens rotations with gates parametrized as in Eq. 39 can be used to prepare a linear combination of Fock states with a fixed number of ones and zeroes on 3 qubits representing the first cavity. We then append an equivalent circuit box for the second cavity. The resulting circuit for the initial state (for a specific value of the detuning) is shown in FIG. 3b.

FIG. 3a and FIG. 3b depict an initial state which is assumed to correspond to the Mott insulator phase. FIG. 3a provides schematic representation of the initial state construction for one circuit box representing a single cavity. The initial state for a single cavity (such as 11A or 11B) is a linear combination of 2 Fock states corresponding either to an excited atom and 0 photons, or to an atom in the ground state and 1 photon. In this FIG. 3a, θ1 is a function of the detuning, Δ. FIG. 3b shows the corresponding quantum circuit 20 for the state constructed using the Givens rotations ansatz and decomposed into rotations 22 and Pauli gates 24. The angle of the rotation gate is a function of the detuning. Note the sub-circuits on the top 3 and the bottom 3 qubits of the register are identical.

### 3.3—Time Evolution of the Wavefunction

The dynamics of the system is described by the exponential evolution operator:

$$Ψ ( t ) = {e}^{- {iH}^{JCH} t} {Ψ}_{0} , \qquad ( 40 )$$

where Ψ₀ is the initial state described in Section 3.2 and H^{JCH} is the Hamiltonian defined in Eq. 35.

The Trotter-Suzuki transformation is to propagate the wavefunction:

$$\begin{matrix}Ψ ( t + dt ) = {e}^{- {iH}^{JCH} dt} Ψ ( t ) = {( {e}^{{iH}^{JCH} Δ t} )}^{{N}_{trotter}} Ψ ( t ) \\ \approx {\prod }_{l} {( {e}^{- {iC}_{l} {P}_{l} Δ t} )}^{{N}_{trotter}} Ψ ( t )\end{matrix} , \qquad ( 41 )$$

where H^{JCH}=ΣₗCₗPₗ is a sum of Pauli strings Pt with corresponding coefficients as in Eq. 34, and Nₜᵣₒₜₜₑᵣ=dt/Δt determines the number of Trotter steps per time step.

Measurements are performed at each time-step up to the characteristic time T=1/J, where the value for the hopping strength J is given in Table 2 above.

By way of example, a measurement is made at time t=m*dt. First, an elementary circuit is constructed corresponding to one Trotter step. Then Nₜᵣₒₜₜₑᵣ*m such circuits are appended to one another. Once this has been done, the resulting circuit is compiled and optimized, assuming no device constraints by default, although it is noted that this may not preserve gate set, connectivity, etc. The optimization then involves removing redundancies, applying Clifford simplifications, commuting single-qubit gates to the front of the circuit, and other compiler passes [16].

The optimal balance may be found between reducing the Trotter error by increasing Nₜᵣₒₜₜₑᵣ and minimizing the circuit depth. In this example, we use dt=0.05 T. By inspecting the corresponding matrices, it has been found that the Trotter error in this example is still acceptable for the system if we use Δt=dt, i.e. Nₜᵣₒₜₜₑᵣ=1 (other configurations may also provide an acceptable Trotter error.

TABLE 3

| | Uncompiled | IBM | H1 |
|---|---|---|---|
| Depth | 529 | 373 | 199 |
| Gates, total | 1862 | 596 | 298 |
| 2-qubit gates | 216 | 245 | 120 |

The number of 2-qubit gates in one Trotter step compiled for different architectures is shown in Table 3 above. In other words, Table 3 shows parameters per one Trotter step, whereby the circuits are compiled for the corresponding gate-sets native for the architecture. The compilation was performed using TKET[16] with an optimization level set to 2.

The circuit parameters are susceptible to the exact optimization strategy and the backend of choice. Moreover, for each time step, the circuit is composed of several sub-circuits and these are re-compiled separately. Due to this re-compilation, the number of 2-qubit gates does not necessarily increase linearly with the number of appended Trotter steps.

### 3.4—Observables

In this section, the physical observables (corresponding to what is actually measured) which reflect the phase transition in the coupled cavities are examined. These observables are time-dependent, so measurements are taken at each time step of the propagation.

### (a) Overlap

The first observable to be considered is Λ(t), which measures the overlap between the initial and the time-propagated wave function at time t:

$$Λ ( t ) = - \frac{1}{L} {log}_{2} ( {\vert 〈 {Ψ}_{t = 0} \vert Ψ ( t ) 〉 \vert}^{2} ) \qquad ( 42 )$$

Equation 42 shows that Λ is zero for the initial state and reaches a maximum when the overlap between the states is minimal. This means that Λ is larger when the system is closer to the superfluid state.

### (b) Total Number of Excitations and the Order Parameter

The system is characterized by the number of polaritonic excitations Nₑₓ, which is conserved, and which represents the sum of atoms in the excited state and photons in each cavity,

$${N}_{ex} = {\sum }_{i} {n}_{i} \qquad ( 43 )$$

$$with$$

$${n}_{i} = ( {b}_{i}^{†} {b}_{i} + {σ}_{ee}^{i} ) \qquad ( 44 )$$

where σₑₑⁱ is the number of atomic excitations in the i^{th} cavity. The total number of excitations is a conserved quantity and its operator commutes with the Hamiltonian.

In terms of Z-Pauli gates, Zⱼ, acting on j^{th} qubit,

$${N}_{ex}^{qubit} = {n}_{1} + {n}_{2} = ( 2 - 0.5 {Z}_{0} - {Z}_{1} - 0.5 {Z}_{2} ) + ( 2 - 0.5 {Z}_{3} - {Z}_{4} - 0.5 {Z}_{5} ) . \qquad ( 45 )$$

The following observable is not conserved:

$$\begin{matrix}{Q}_{ex}^{qubit} = {n}_{1}^{2} + {n}_{2}^{2} \\ = ( 5.5 - 2 {Z}_{0} - 4 {Z}_{1} - 2 {Z}_{2} + {Z}_{0} {Z}_{1} + {Z}_{1} {Z}_{2} + 0.5 {Z}_{0} {Z}_{2} ) ++ \\ ( 5.5 - 2 {Z}_{3} - 4 {Z}_{4} - 2 {Z}_{5} + {Z}_{3} {Z}_{4} + {Z}_{4} {Z}_{5} + 0.5 {Z}_{3} {Z}_{5} )\end{matrix} \qquad ( 46 )$$

The total excitation variance is also a time-dependent quantity:

$$δ {N}^{2} ( t ) = {\sum }_{i}^{L = 2} [ 〈 {n}_{i}^{2} 〉 - {〈 {n}_{i} 〉}^{2} ] \qquad ( 47 )$$

The order parameter, denoted by “OP” and defined by

$$OP = \frac{1}{T} {\int }_{0}^{T} δ {N}^{2} ( τ ) d τ , \qquad ( 48 )$$

reflects the mean variance of the total number of excitations Nex.

The system becomes increasingly disordered as it moves farther away from the Mott insulator state. In the superfluid state, each cavity can hold up to 2 photons, which means that the cavity array is not “ordered”. Note that since the two cavities are identical, it is not necessary to measure the polaritonic excitation variance for each of them. Rather, the polaritonic excitation variance may be determined by measuring [symbol] ni [symbol] . (t) in one cavity and the multiply the result by a factor of 2. This approach has bee verified with statevector simulations. This observation is especially relevant for hardware experiments since fewer measurements are involved.

### 4) Results

This section presents simulation results for two coupled cavities (see in Section 3) performed with the Holstein-Primakoff transformation for the multiphoton regime (see Section 2.2). The quantum statevector and measurement-based results are compared with a classical simulation to demonstrate the validity of the approach described herein as well as its efficiency. The effect of noise is then analysed.

### 4.1—Noiseless Backend Results

### (a) Overlap

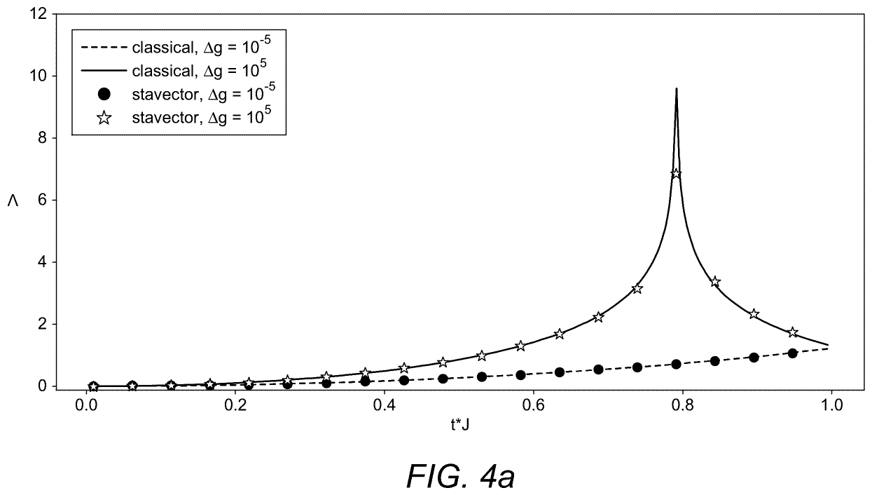

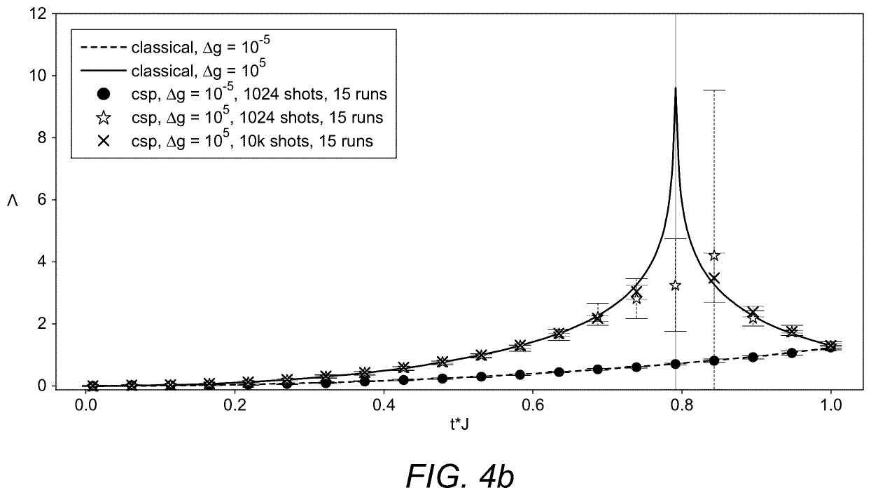

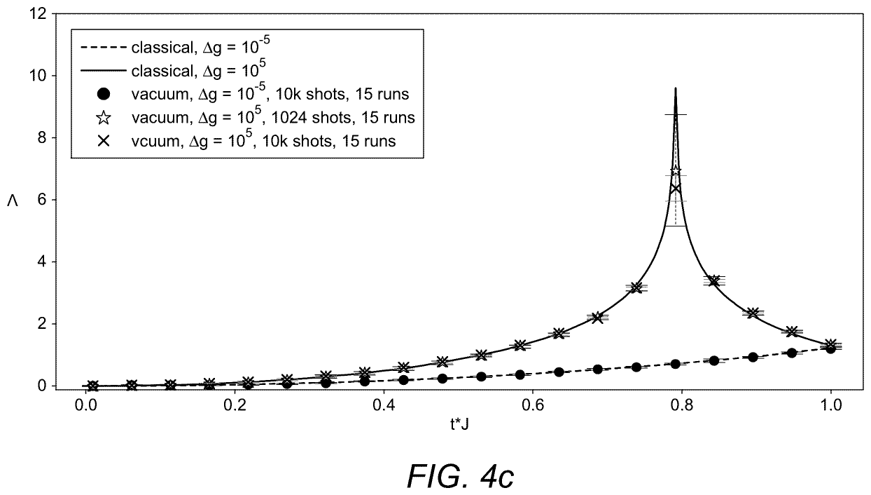

The phase transition is examined by analyzing Λ(t), which is a function of the overlap of the initial state and the evolved state. Λ(t) is given by Eq. 42 in Section 3.4 (a). FIG. 4a, FIG. 4b and FIG. 4c show the overlap Λ(t) (see Eq. 42) from firstly the classical and statevector results (FIG. 4a), secondly from the classical and Canonical Swap Test Protocol (CSP) results (FIG. 4b), and thirdly from the classical and Vacuum Test simulation results (FIG. 4c). This value of this parameter Λ(t) reflects the phase transition and is related to the overlap between the initial Mott-insulator state and the time-evolved wavefunction. For the corresponding Δ values, please refer to the labels in the respective legend boxes.

FIG. 4a displays the classical and statevector results for Λ(t). The black curves (no markers, solid upperline and dashed lower line) represent the classical results as described in detail in [26]. In this approach, each operator, including the Trotter operator, is represented with its corresponding matrix, and the dynamical simulation is carried out by matrix multiplication. For better accuracy, the time step in the classical calculation is ten times smaller than the time step used in the subsequent quantum calculations. It has been verified that if Δ, g, ω0, J are similar to those in [26], then the results presented herein are the same as the results from [24].

Each classical curve in FIG. 4a corresponds to a different detuning value Δ/g={10-5, 105}, with g being fixed (refer to Table 2 above). When the detuning is negligible, Λ(t) remains small and gradually increases with time, corresponding to a small-scale “leakage” of the Mott insulator wavefunction. As the detuning becomes more significant, the system undergoes a phase transition. For Δ/g=105, a sharp, nearly delta function-like peak appears around 0.81/J. The peak position shifts slightly depending on the detuning value (not shown).

The data points shown with circles and stars in FIG. 4a correspond to the quantum statevector simulations for the two values of the detuning. The statevector results very closely match the classical results. The small discrepancy around the peak at t*J≈0.8 at Δ/g=105 can be attributed to the Trotter error due to the larger time step in the state vector simulations, which affects the accuracy when reproducing the cusp.

After confirming the accuracy of the mapping scheme disclosed herein for generating statevector results, shot-based quantum calculations of Λ(t) are now considered. Measuring the overlap between the initial state |ϕ [symbol] and the propagated wavefunction |ψ(t) [symbol] may be performed using various measurement protocols; for present purposes, the measurement is based on a comparison between the ancilla-based Canonical Swap Test Protocol (CSP) and a protocol referred to herein as a Vacuum Test [38]. We ran each setup Nᵣᵤₙₛ=15 times to make sure enough data was collected to conclude about the applicability of the protocols. The mean value of Λ and the error bars showing the confidence interval, CI, are presented in FIG. 4. The standard deviation, σ_{Λ}, is calculated based on the standard deviation of the measured overlap squared. The confidence interval corresponds to the confidence level 99%. For each time step,

$$P = {\vert 〈 {Ψ}_{t = 0} \vert Ψ ( t ) 〉 \vert}^{2} \\ {σ}_{Λ} = \sqrt{{( \frac{d Λ}{dP} {σ}_{P} )}^{2}} \\ CI = 2.576 * σ Λ / \sqrt{{N}_{runs}} \qquad ( 49 )$$

Note that in FIG. 4b, the left-hand side has close alignment (and hence overlap) between the locations of the medium-sized light crosses (e+5, 10k shots) and the locations of the dark stars (e+5, 1024 shots). In FIG. 4c across the whole plot (apart from the sharp peak), there is close alignment and hence overlap between the locations of the medium-sized light crosses (e+5, 10k shots) and the locations of the dark stars (e+5, 1024 shots).

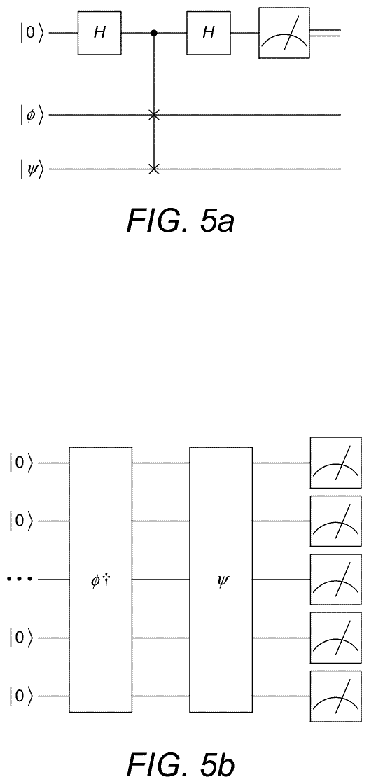

FIGS. 5a and 5b provide a schematic representation of the overlap measurement protocols used for Λ from Eq. 42. The circuit for CSP is shown schematically in FIG. 5(a). The test involves constructing a register with two sub-registers corresponding to the overlapping wavefunctions, and the result is measured on the ancillary qubit similar to the Hadamard test. The probability of finding the ancillary qubit in the |0 [symbol] state is then ½+½| [symbol] ϕ|ψ [symbol] |². The circuit width is twice the number of qubits in the state plus one. The multicontrol gate shown in FIG. 5a also leads to increased depth. Notably, since the measurement is performed on the ancillary qubit only, with a modest number of shots and when the true value of P=| [symbol] Ψₜ₌₀|Ψ(t) [symbol] |² is close to zero, statistical deviations may lead to a negative result in a particular run (|0 [symbol] is measured slightly less often than |1 [symbol] ). This result is nonphysical, however, it cannot be discarded from the statistics since otherwise a bias would be introduced. Instead, many runs are required to achieve the true near zero mean for P. At the same time, for the almost-zero overlap but non-zero standard deviation σ_{P}, the confidence interval may become large since

$$\frac{d Λ}{dt}$$

is also large (see Eq. 49).

The results of shot-based CSP simulation are shown in FIG. 4b. For detuning Δ/g=10−5, shown with (circles along the lower classical curve), the wavefunction closely resembles a Mott insulator and changes smoothly on the entire timescale, leading to a smooth monotonically increasing Λ(t). In this case, the process is near-resonant, and light-matter interaction within each cell dominates the process. The CSP measurement of the observable with 1024 shots is thus very accurate. nearly matching the classical data. The confidence interval does not exceed 0.1. In contrast, the accuracy is worse for very large detuning. In particular, there is a discrepancy in the region around the sharp maximum of Λ(t), when the overlap between the initial and evolved wavefunctions is small. Stars overlaying the upper classical curve show the mean result of the measurement with 1024 shots. The peak position is not reproduced well. The error bar around the peak is very large. The quality is increased when runs are performed with 10000 shots (crosses close to the upper classical curve). At the peak, the overlap is found to be almost zero leading to large values of A. In contrast, the error around the peak remains large as well.

Next, a vacuum test is used, see FIG. 5b, which works by appending the circuits corresponding to [symbol] ϕ| and |ψ [symbol] and measuring the results directly on every qubit. This eliminates the need to duplicate the number of system qubits and add an ancillary qubit, but increases the depth of the circuit. The width of the circuit is that of the wavefunction. The result is equal to the probability of measuring the all-zero state on all qubits.

The corresponding Λ is shown in FIG. 4c where the circles (bottom) and stars (top) correspond to the noiseless result for Δ/g=10-5 and 105, respectively. Crosses closely following the upper (classical) curve show the result for the large detuning and large number of shots. Again, in the case of small detuning, the simulation results lie directly on top of the classical ones well within the confidence interval of 0.1. For the large detuning, the results are also in good agreement with the classical prediction, except for the peak region, where the obtained values are very large and lie outside the plot range. Similarly to what is described above, this would correspond to the situation when the measured overlap is very close to zero, so Λ(t) approaches infinity. A vertical dashed line has been included in FIG. 4c, to indicate this peak. The statistical error is small for both small and large detuning everywhere except the peak point.

Comparing FIG. 4b and FIG. 4c shows that the Vacuum Test is more suitable for the cavity QED problem under consideration. Using the CSP protocol overlooks the singularity around the peak at large detuning and requires many runs and a large number of shots because the measurement is performed on a single qubit. At the same time, smoothing of the peak makes the CSP protocol less suitable for studying the phase transition. The Vacuum Test, on the contrary, amplifies the transition.

Importantly, the Vacuum Test performs better with a modest number of shots since its results almost exactly match the classical ones at all times before and after the cusp. If the number of shots is as large as 10000, the Vacuum Test still outperforms CSP in terms of accuracy on either side of the cusp.

### (b) Total Number of Excitations and the Order Parameter

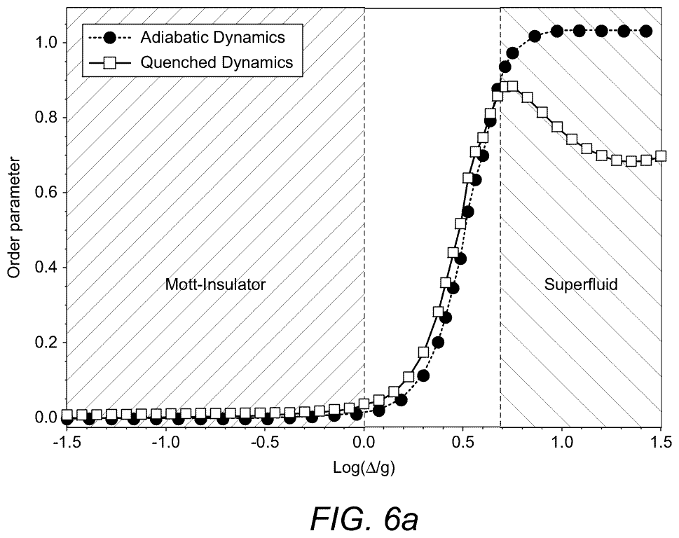

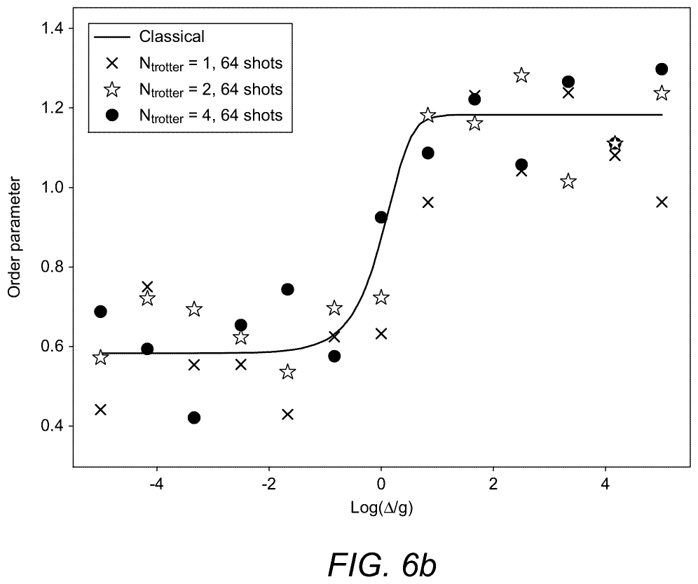

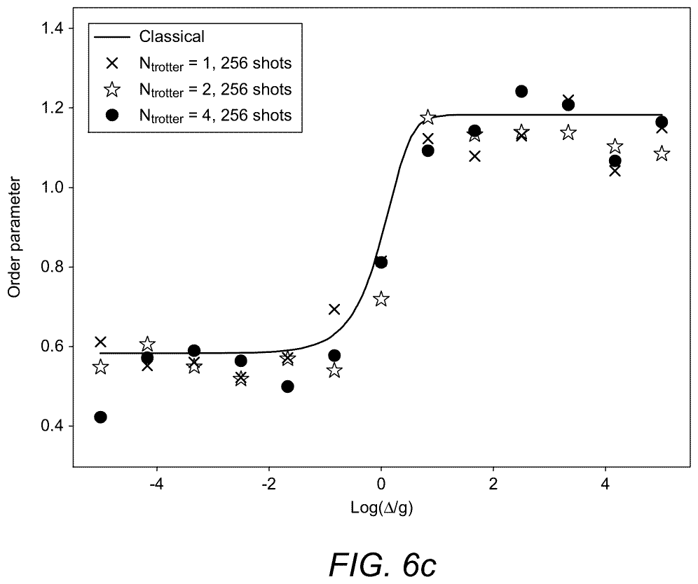

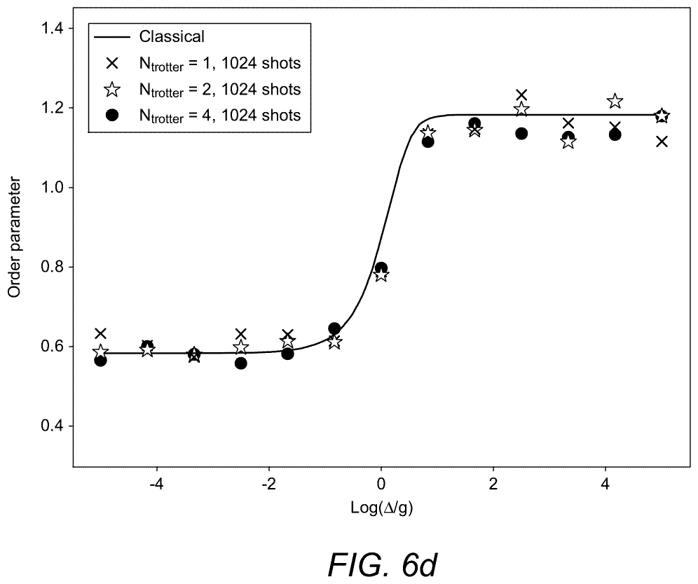

Turning now to the calculation of the order parameter, OP, from Eq. 48, this parameter is obtained by finding the mean value of the variance after Trotterized time propagation. The results are shown in FIGS. 6a to 6d, plotted as a function of detuning (rather than time). In particular, FIGS. 6a-6d shows the order parameter as a function of the detuning. The black curve in FIGS. 6b-6d represents classical simulations, while dots and stars represent noiseless shot-based simulations with various numbers of Trotter steps per time step (Nₜᵣₒₜₜₑᵣ) and different numbers of shots. Nₜᵣₒₜₜₑᵣ is the number of Trotter steps per time step.

Prior to presenting details of results from the present approach, the classical simulation from [1] will be discussed and interpreted. In [1], the initial order parameter is close to zero, indicating that the system is in the Mott-insulator state and adding more photons to each cell is prohibited. As the detuning becomes larger, a phase transition occurs. The resulting curve for the order parameter has two distinct plateaus-see FIG. 6a, which is a chart adopted from [1] to show the comparison with the QED classical study.

In contrast to [1], the present approach involves a much stronger coupling for reasons mentioned above in Section 3.1. Under the conditions described in Table 2, the classical curve for the order parameter is shown as the black solid line in FIGS. 6b-6d. As for the result in [1], this curve features two plateaus which are connected by a smooth transition around Λ/g= [symbol] (1). The initial order parameter is around 0.6 at small detuning before the phase transition. The nonzero value is due to the variance not being consistently small throughout the characteristic period in the strong-coupling regime.

The effect of varying the number of Trotter steps (within one time step) and the number of shots on the results of a noiseless simulation has been investigated. The number of time steps remains constant at 20. FIGS. 6b-6d provide three series of results: 64 shots (crosses), 256 shots (circles), and 1024 shots (stars) (respectively), with each plot including different numbers (1-4) of Trotter steps per time step. FIGS. 6b-6d show that, in the given range of Trotter step sizes and shot numbers, increasing the number of shots has a greater impact on the precision of the results compared to reducing the Trotter step size. In addition, as discussed above, since the cavities are identical, measuring one cavity with X shots is equivalent to measuring L cavities with X/L shots each.

The best result in FIGS. 6b-6d is provided by FIG. 6d using 1024 shots and with Ntrotter=4; this configuration had a mean error of only ϵ=0.02. Importantly, these results show that the phase transition can be reproduced with a modest number of shots. This is because the required level of accuracy in this problem is different from that required in typical quantum chemistry simulations. Instead of seeking to find the exact value of a parameter, the approach described herein aims to determine the approximate value of the detuning at which the phase transition occurs.

### 4.2—Noisy Backend Results

To assess whether current quantum computers can handle the problem described herein, emulator-based simulations were performed using two different architectures. For the superconducting device, the Aer backend was used with a noise model that matches that of the IBMQ Montreal machine [39]. In addition, the H1-2E emulator from Quantinuum was used to simulate an ion-trap device. In general, superconducting devices offer faster simulations but with more noise, while ion-trap machines provide lower noise but slower simulations.

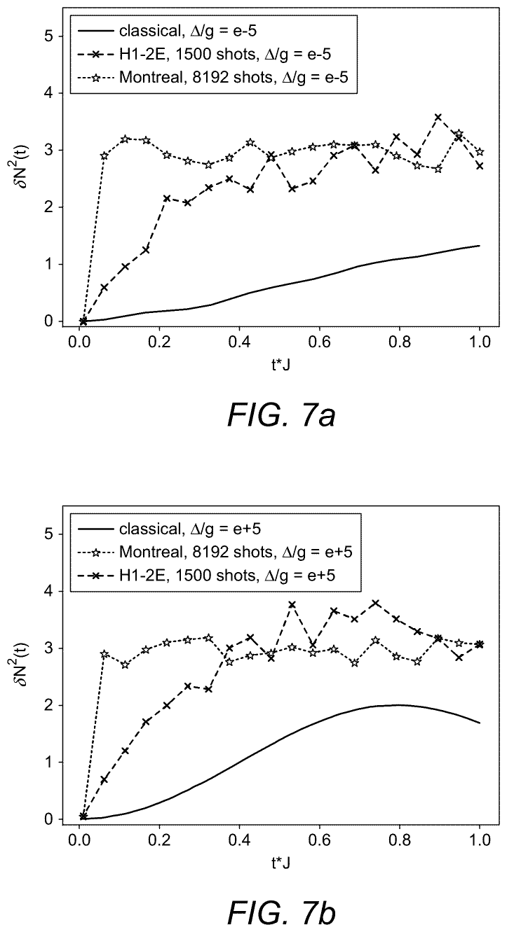

Although a final goal is to observe the phase transition such as in FIGS. 6a-6d, the order parameter for each value of the detuning is calculated as a mean over time, and this does not allow the performance of the dynamics algorithm to be assessed in detail. Instead of reproducing the order parameter graph with a noisy simulation, FIGS. 7a and 7b show the curves for the variance in the number of excitations, δN², see Eq. 47, as a function of time, for two extreme values of the detuning, Δ/g={10-5, 105}.

In particular, FIGS. 7a and 7b show time-dependent variance in the number of excitations, δN²(t), as per Equations 43, 45, 46, 47. FIG. 7a shows results for small detuning Δ/g=10-5, while FIG. 7b shows results for large detuning Δ/g=105.

When the detuning is negligible, we expect the curve to look like the black curve in FIG. 7a, i.e. to monotonously increase. For very large detuning, the classical result in FIG. 7b has a maximum at t≈0.8/J. The order parameter, as the mean of δN²(t), will therefore be sensitive to the time-dependent behaviour of the number of excitations. Observing the effect in an experiment across the full detuning range involves detecting a transition between the two plateaus (see FIGS. 6a-6d). If a noisy result is shifted up from the classical result due to some coherent noise, but that the shape of the curve is reproduced, detection of the phase transition is expected. Noise mitigation techniques such as, for example, zero-noise extrapolation may also potentially improve the result.

The results obtained from an ion-trap emulator are shown in FIGS. 7a and 7b. Although the absolute value of the variance becomes significantly higher than expected after just a few Trotter steps, the overall shape of the curve is reproduced. Due to limited computational resources, the full curve (such as provided in FIGS. 6a-6d) was not formed for the order parameter before attempting to mitigate the noisy run.

Nevertheless, emulating the process on a Qiskit Aer backend (www.qiskit.org) with a realistic noise model (see FIGS. 7a, 7b) produces qualitatively similar results for both small (left panel) and large (right panel) detuning. Both sets of results start at some small values and quickly reach a plateau of δN²≈3. The reason for this behaviour can be found in look at Eqs. 43, 45, 46, and 47. If a very large noise is assumed, all the results for nonconstant operators average out and only the constant value survives, ( [symbol] n₁² [symbol] )− [symbol] n₁ [symbol] ²+ [symbol] n₂² [symbol] − [symbol] n₂ [symbol] ²)_{noise→∞}→1.5+1.5=3, as can be seen from FIGS. 7a and 7b.

### 4.3—Scaling

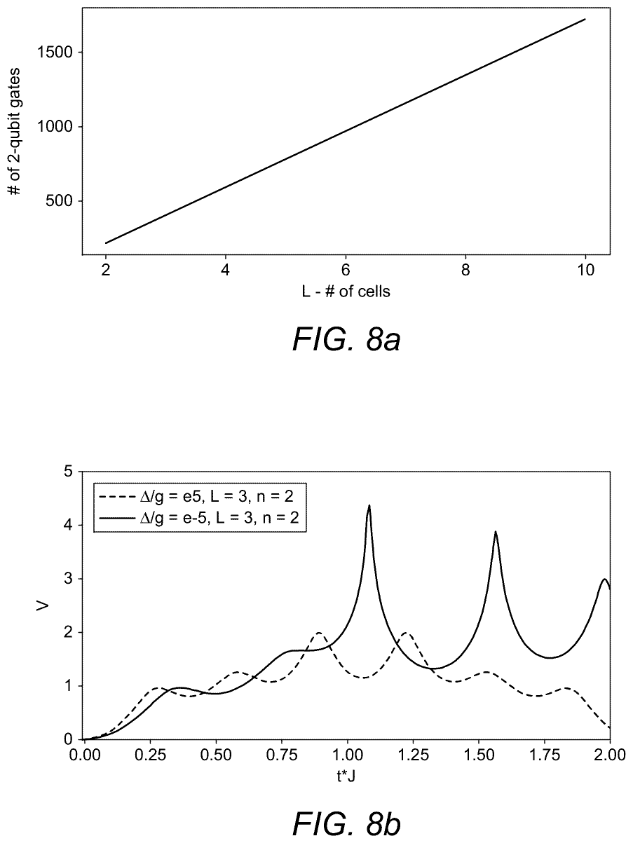

An analysis has been performed to investigate how the circuit parameters will scale for larger systems with more cavities (cells), namely L>2. In this context, FIG. 8a shows the number of 2-qubit gates per one Trotter step. The circuits are generated by TKET without taking any architecture into account. For L=2, the circuit is the same as in the “Uncompiled” column of Table 3. L=10 corresponds to a 30-qubit calculation. FIG. 8b shows a classical simulation of Λ(t) for a given number of cells (L_), a given number of photons in the band n, and different detuning between the two lines shown in FIG. 8b.

More particularly, FIG. 8a shows that the number of 2-qubit gates per uncompiled circuit with one Trotter step changes linearly. Note that one extra cell corresponds to 3 extra qubits, so the scale goes from 6 qubits (as is the focus of this study) to 30 qubits. In contrast, FIG. 8b shows classical results for L=3 and n=2, where n follows Eq. 37 for the time scale beyond T=1/J. The solid line in FIG. 8b corresponds to smaller detuning, the dashed line to larger detuning. For larger detuning, there is a characteristic period for a given number of cavities and a higher number of photons changes. For smaller detuning, the result does not appear to be periodic, neither is it monotonic for t<2/J. Therefore, for a quantum simulation of larger systems, not only a bigger register but also a longer simulation time are needed.

### 5) Discussion and Further Steps

A method has been presented herein for mapping bosons in a mixed spin-boson system that utilises the inverse Holstein-Primakoff mapping. The method has been tested in the multiphoton regime and on systems with several atoms described by spin operators. Comparing the results from this method with classical simulations confirms the validity of the proposed mapping, which is expected to be at least as efficient as binary mapping. Further, the results presented herein with noiseless simulations and with only stochastic error present demonstrate that a phase transition can be detected with a relatively large Trotter step and a modest number of shots which is realisable on near-term quantum hardware.

Upon testing the model on noisy emulators, it is found that further improvements to the dynamics simulation algorithm may be desirable due to the large number of 2-qubit gates per time step in the standard Trotter-Suzuki scheme, which increases the noise introduced in the simulation. The ion trap runs suggest that the use of noise mitigation may lead to more accurate simulation results. However, the noise level of the superconducting machines is relatively high for noise mitigation techniques alone to be effective. Thus, further exploration of other algorithms, such as those relying on randomly compiling a Trotter step circuit [40], particularly for higher values of the detuning, may provide improved results in combination with noise mitigation.

The approach described herein may be generalised and extended to systems with more photons or higher maximum spin values. For very high spins, it would be beneficial to analyze the error introduced by truncating the Newton series. With tens of logical qubits available, one may be able to simulate processes involving hundreds to thousands of photons. This will open the door to modelling important collective effects in cavity QED, such as super-radiance (for example). In regards to the unitary circuit mapping, an alternative approach to Trotter-Suzuki decomposition is using block encoding techniques [41] which prove to be more efficient in the asymptotic limit. These methods could be combined with Holstein-Primakoff mapping with higher spins as well as for boson operators. In larger systems, the issue of the number of shots that can be performed realistically may become important. In this case, techniques such as classical shadows [42] may be exploited to reduce the simulations cost.

Additionally, the approach described herein may be modified to map polaritonic excitations (rather than dividing the register into spin and boson components). This approach may potentially reduce the number of qubits involved. It is intended that once noise mitigation has been tested successfully on an emulator, the system may be run on real quantum hardware.

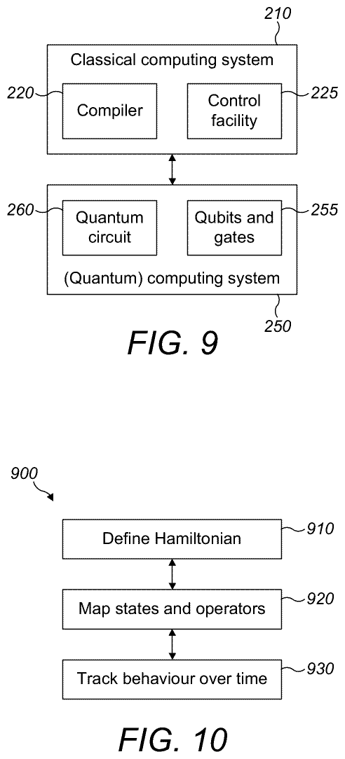

FIG. 9 is an example of a computing system (platform) for performing the processing (operations) described herein. The computing system may comprise a classical computing system 210 and a quantum computing system 250. The classical computing system 210 may comprise one or more computers (devices), likewise the quantum computing system 250 may comprise one or more computers (devices).

The quantum computing system 250 is shown including at least one quantum circuit 260 which includes at least one qubit and at least one gate 255. The quantum circuit 260 can be considered as somewhat analogous to a compiled program (low-level code) which has been adapted to run on the specific hardware implementation of the quantum computer, such as by providing the appropriate number and connectivity of the qubits and gates 255. In FIG. 9, the “Quantum” of computing system 250 is shown in brackets because in some cases, the quantum computing system 250 may be replaced (implemented) by a classical computing system which simulates (emulates) the quantum computing system. In some cases (and as described herein), the quantum circuit 260 may be run on such a simulator to test and control the operation of the quantum circuit 260 to support software and/or hardware development. In some cases, the simulator may implement a noise-free environment, allowing for quantum circuits to be tested without having to specifically address issues of decoherence.

The classical computing system 210 is shown in FIG. 9 as including a compiler 220 and a control facility 225. The compiler 220 may be used to process higher level code or other representations to produce desired quantum circuits 260. The control facility 225 may manage and implement various interoperations between the classical computing system 210, for example, transferring a compiled quantum circuit (program) to the quantum computing system 250 for execution.

FIG. 10 is a schematic flowchart illustrating an example of a method for use in investigating quantum electrodynamic effects in physical systems. The method commences at operation 910 to defining a Hamiltonian representation comprising states and operators for the bosonic and spin components of the physical system. At operation 920, the states and operators of the complex physical system are mapped onto qubits and Pauli gates of a quantum circuit for execution by the quantum computing system. At operation 930, the behaviour with time of the complex physical system is tracked.

In general terms, operation 910 is generally performed on a classical computing system, such as computing system 210 in FIG. 9. The mapping of operation 920 may likewise be performed on a classical computer system such as computing system 210 of FIG. 9 and typically concludes with a quantum circuit. This quantum circuit corresponding to the method of FIG. 10 may then be loaded onto a quantum computing system, such system 250 in FIG. 9, for execution by the quantum computing system. In some cases, the quantum computing system for performing operation 930 may be implemented by a classical computer which incorporates an emulator for a quantum computing system. This latter configuration is common for developing and testing programming (e.g. quantum circuits) intended for current and/or future quantum computers.

The system shown in FIG. 9 and/or the method of FIG. 10 may be used, inter alia, to investigate or simulate a phase transition in an insulator with a system of coupled cavities containing interacting atoms and photons. This technology is of interest in the field of cavity quantum electrodynamics (QED), a fast-growing area studying the interactions between atoms or other spin systems and quantized electromagnetic fields. In QED, researchers confine matter-field interactions using quantum-scale reflective cavities, making it possible to explore critical aspects of the coupling between atoms and fields using a quantum computing system. As disclosed herein, a boson-to-qubit cavity QED encoding scheme has been developed which supports an efficient and intuitive mapping of each quantum operator onto a circuit in the quantum computer. For example, an initial state may be constructed corresponding to an insulator, and the system may then be allowed to evolved, leading to a phase transition in which the system may be transformed into a superfluid state enabling unobstructed photon flow between multiple cavities. Accordingly, under appropriate conditions, a quantum computer provides a facility for investigating cavity QED systems, including phase transitions thereof.

Cavity QED may be used, for example, to study a photon emitted when an electron drops to a lower energy level. Positioning an atom—or indeed any particle that can take a ground and an excited state—within a compact reflective cavity ensures that the photon, emitted spontaneously during the atom's transition to its ground state, rebounds within the cavity. This bouncing back and forth facilitates a field-matter interaction. In the context of a strong interaction, commonly referred to as “strong coupling”, photon confinement may generally be achieved if the wavelength of the photon does not (considerably) surpass the dimensions of the cavity. Such a setup may also be used in chemistry to control chemical reaction rates via electromagnetic pulses, an idea that is of potential interest fields such as materials and molecular science.

Cavity QED is a very active field interesting for industrial application and is relevant, inter alia, for light-driven and light-modulated chemistry. Efficient cavity QED simulations are also of potential interest for applications such as development of quantum computers, quantum sensors, and quantum key distribution.

The system shown in FIG. 9 and/or the method of FIG. 10 may be used, inter alia, to encode bosonic operators to a separate part of a qubit register. Due to this register separation, the encoding technique may be used to map a purely bosonic system and/or to map a mixed spin-boson or fermion-boson system. The boson-to-qubit encoding may involve: (i) using the inverse Holstein-Primakoff transformation to convert boson operators to spin operators (as compared to the direct transformation, which maps spins to bosons), (ii) encoding the spin operators to the qubit register. This approach may include the multiplication and inversion of operators represented by diagonal matrices—this can be done classically or on a circuit. As described above, a Newton expansion may be used for the square root operator for the inverse transformation. The approach described herein may also exploit the representation of higher spin operators and is suitable for the regime involving multiple bosonic excitations. One potential benefit of this encoding is to allow the treatment of different types of particles on an equal footing.

The present approach may be used (as described above) to simulate a phase transition from the Mott insulator to a superfluid on a quantum computer. This approach may include: (i) preparing the initial state. The Mott insulator state typically involves constructing a linear combination of qubit (Fock) states for each cavity which may be done using the Givens rotations ansatz; (ii) encoding the spin-boson Hamiltonian using the inverse Holstein-Primakoff transformation; (iii) constructing the observables such as the overlap squared and the related Lambda-parameter, the polaritonic excitations number operator and its variance for each cavity; (iv) driving the time evolution, for example, by using the first-order Trotter-Suzuki approximation of the evolution operator (the strong-coupling regime is shown to allow using big Trotter steps such that one time step equals the Trotter step); and (vi) take measurements with respect to the phase transition. Direct protocols which do not involve ancillary qubits are suitable for this task, and a modest number of shots is sufficient to identify the phase transition. Note that since the physical configuration may involve multiple cavities having an identical nature as one another, measurements of the order parameter may be performed for only for one of the cavities.

Some embodiments of the method illustrated schematically by the flowchart 900 shown in FIG. 10 comprise a method for tracking over time quantum electrodynamic, QED, effects in a physical system containing bosonic components and other spin components using a quantum computing system. The method comprises defining a Hamiltonian representation of the physical system in 910. The Hamiltonian representation may comprise states and operators for the bosonic components and other spin components of a physical system comprising a plurality of cavities in which the bosonic and other spin components of the physical system are located. The bosonic and other spin components of the physical system interact with one another according to quantum electrodynamics and the bosonic components of the physical system are able to hop between cavities. The hopping may cause the cavities to be coupled, in other words, interconnected. The method may further comprises mapping the states and operators in 920 from the Hamiltonian representation of the physical system to compile a quantum circuit simulating the physical system for execution on the quantum computing system. The method may further comprise tracking the behaviour of the physical system in 930 by executing the quantum circuit using hardware of the quantum computing system to measure observables and using the measured observables to track a QED behaviour over time of the physical system.

In some embodiments, the physical system comprises one or more atoms or molecules located in the cavities which are described by spin operators.

In some embodiments of a method for tracking over time QED effects in a physical system such as that described herein, for example, the method illustrated schematically in FIG. 10, the operators for the bosonic components are expressed as higher-spin operators. The mapping then maps the higher-spin operators for the bosonic components and the spin operators for the other spin components of the physical system to compile the quantum circuit for the quantum computing system. The higher-order operators for the bosonic components can be obtained by subjecting bosonic operators in the Hamiltonian to a transformation, for example, an inverse Holstein-Primakoff transformation such as that described herein above for a physical system comprising two or more cavities.

In some embodiments, the physical system comprises a multiphoton regime and the operators for the bosonic components in the Hamiltonian are transformed using the inverse Holstein-Primakoff transformation into higher-spin operators which are mapped with the spin operators for the other spin components to a quantum circuit for simulating the multiphoton regime when executed on the quantum computer.

In some embodiments, the mapping compiles a quantum circuit by using bosonic components of the Hamilton which are expressed as higher-order spin operators obtained from using an inverse Holstein-Primakoff transformation on the bosonic operators. The qubit representations of the compiled circuit are found separately for the inverse square root operator and spin ladder operators of the Hamiltonian. The qubit representations for the operators are exponentiated using the operator Trotter-Suzuki decomposition and the circuit is optimized for a backend system. The optimization may be specific for the quantum hardware of the intended backend system, in other words to the size of the register and its hardware architecture, for example, if the register comprises a plurality of sets of qubits. In some embodiments, when performing the mapping of the inverse square root operator a Newton expansion is used, for example, one of the example Newton series expansions described herein may be used.

The circuit may be compiled and optimized using a suitable quantum toolkit software development platform for developing and/or executing gate-level quantum computation, for example a software platform such as TKET. In some embodiments, the circuit may be optimized to reduce the number of CNET gates required to represent the evolution operator for the wavefunction representing the physical system being simulated.

In some embodiments, instead of the backend system comprising quantum computer hardware, the backend may comprise a classical computer emulation of a quantum computing system-simulating the operation of a quantum computing system.

The backend system may comprise a quantum computer comprising quantum computer hardware which is configured as part of a hybrid quantum and classical computer system to implement the disclosed technology.

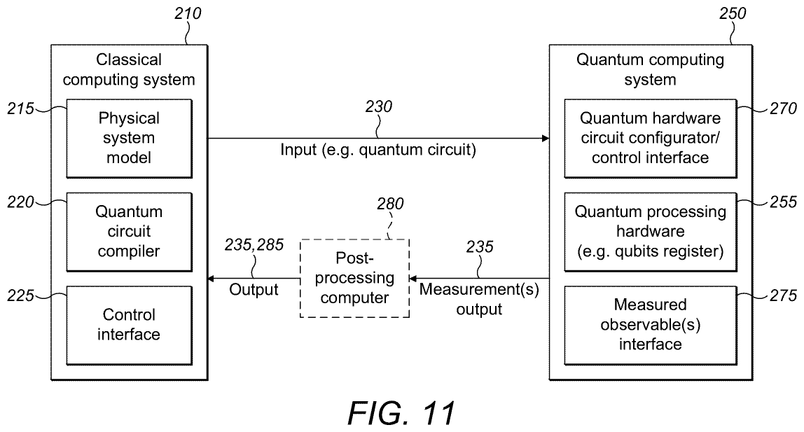

FIG. 11 illustrates schematically a more detailed example embodiment of a hybrid quantum computer system which may comprise in s the hybrid quantum computer system illustrated in FIG. 9. The example hybrid computer systems shown in FIGS. 9 and 11 may be configured to implement a method of tracking a behaviour of a physical system according to the disclosed technology, for example, a method 900 such as that shown in FIG. 10 and as described herein and also to implement the methods 1300, 1400 and 1500 described below which may implement embodiments of the technology disclosed herein above and below.

In FIG. 11, an example classical computing system 210 comprises software and hardware via which a model 215 of a physical system, such as one of the physical systems disclosed herein, may be developed or retrieved from a suitable storage medium. A quantum circuit compiler 220 may be used to map the physical system model 215 to a quantum circuit of the quantum computing system 220. An example of a quantum circuit compiler 220 comprises a quantum circuit software development kit such as TKET. A control facility such as a control interface 225 may be used to cause input 230 comprising the compiled quantum circuit to be sent by the classical computing system 210 to a quantum computing system 220 for execution. Although not shown for the sake of clarity, the classical computer system 210 also includes, as would be apparent to anyone of ordinary skill in the art, other elements which are essential for its operation, for example, it may a power source, memory, processor(s) and/or processing circuitry, controller(s) and/or control circuitry, user interface components, any display(s), or communications module(s) etc., etc.

In FIG. 11, the example quantum computing system 250 comprises a control interface 270 which processes input 230 to configure the quantum computing processing hardware 255 to execute the quantum circuit compiled by the classical computing system 210. The processing hardware 255 may comprise a qubit, qutrit, or qudit register as described herein above which is used to represent the initial and evolving states of the quantum circuit. The initial states of the compiled quantum circuit will evolve based on operations performed using quantum circuit gates which act on one or more qubits representing the initial states to update their states and which may also act on updated states, and measurement circuitry (not shown in FIG. 11 for clarity) is used to obtain measurement(s) of observables as the quantum circuit is executed. The observed measurables are provided as output 235 via a suitable measured observable(s) interface 275 and may be subject to post-processing at a classical post-processing computer 280 before being provided as output 285 to the classical computing system 210 and/or made available to any another classical computer system. Alternatively, the measurements of the observables obtained from executing the quantum circuit on the quantum computer may be provided as output 235 for processing on the classical computer system.

In some embodiments, the quantum computer or simulated quantum computer shown as quantum computer 250 in FIGS. 10, 11, and 12 may be provided as a remote quantum computing service. Alternatively, it may be provided as a remote simulated quantum computing service.

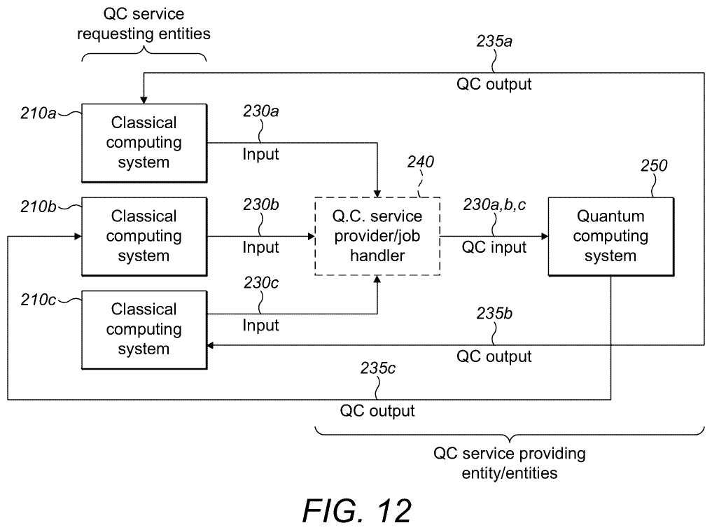

FIG. 12 is a schematic diagram illustrating such an example embodiment of a quantum computing as a service system via which a quantum computer 250 may be remotely configured by any one of a plurality of different classical computer systems 210a,b,c to implement a method of tracking a behaviour of a physical system according to the disclosed technology.

The system shown schematically in FIG. 12 allows more access to quantum computer hardware-based processing system as many classical computers 210a,b,c as shown in the example may compile quantum circuits for the same hardware architecture of back-end quantum computer 250. An access portal 240 may be used to provide access to the quantum computing service to requesting entities such as computers 210a,b,c in the example shown. The access portal may also be configured to handle any queue of compiled quantum circuits so these are passed in a job order on to the quantum computing system 250 for processing on quantum hardware. It will be appreciated that the access portal 240, is shown separately in FIG. 12 from the quantum computer system 250 as the access portal is implemented on a classical computer system.

Some embodiments of the disclosed technology comprise executing a compiled quantum circuit on quantum hardware which performs the quantum processing using quantum circuitry. In some embodiments, the quantum computer may have a superconducting architecture for implementing the quantum circuitry in hardware.

Alternatively, an ion trap architecture or neutral atom architecture may be used to implement the quantum circuitry in hardware. In some embodiments, alternatively, a quantum computer having one of the above architectures could be simulated on a classical computer and used instead.

Some companies including IBM have developed quantum computers with a superconducting architecture, and examples of quantum computers with an ion trap architecture are Quantinuum's H1 and H2 quantum computers. Companies including QuEra have developed quantum computers based on a neutral atom architecture.

In some embodiments, the quantum computer comprises a quantum hardware architecture comprising hardware qubits, qutrits or qudits for implementing the quantum circuit.

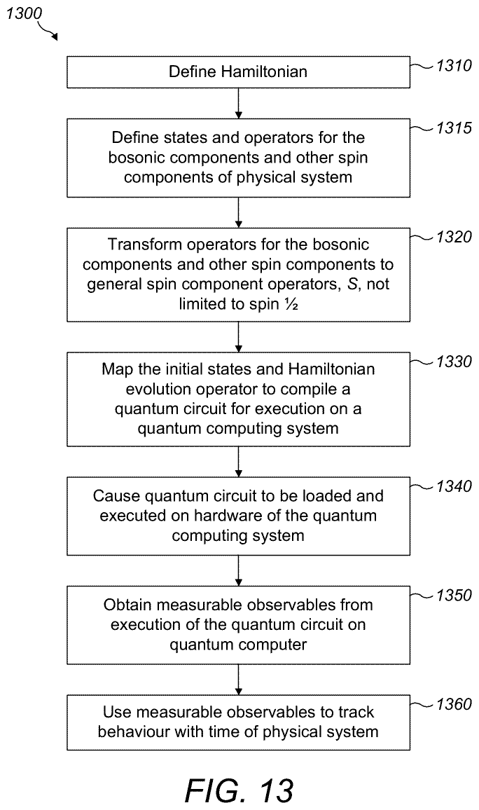

In some embodiments, the method of tracking a behaviour of a physical system, such as the method shown schematically in FIG. 10, or the methods described later herein below in FIGS. 13, 14 and 15 is implemented using a hybrid quantum computer system such as that shown in FIGS. 9 and 12, or by using the quantum computing system as a service shown in FIG. 12 where quantum computer hardware on quantum computer 250 is made available for executing a quantum circuit compiled on a classical computer system 210a,b,c as a cloud-based quantum computing service. The measurements obtained from executing the quantum circuits provided as input 230a,b,c are processed by the quantum computer 250 are then returned as output 235a,b,c to a nominated classical system, which may be the classical computer system 210a,b,c, which provided the compiled quantum circuit or a different one specified in the quantum processing job input 230a,b,c. Not shown in FIG. 12 is any classical computer system post processing the measurements of any observables which may be performed in some embodiments.

In some embodiments, the classical computer system is used to prepare and compile the quantum circuit for execution by the quantum computing system by performing: defining the Hamiltonian representation of the physical system and mapping the states and operators from the Hamiltonian representation of the physical system to compile the quantum circuit simulating the physical system. The method may further comprise the classical computer causing the quantum computer system to load the compiled quantum circuit on the quantum computer hardware, execute the quantum circuit to measure the observables, and provide the measured observables to the or another classical computer system for tracking the QED behaviour over time of the physical system.

The compiled quantum circuit may comprise initial states for the bosonic and other spin operators of the physical system and an evolution operator for the initial states derived from the Hamiltonian and one or more measurement circuits for measuring observables as the quantum circuit is executed on the hardware of the quantum computing system. The mapping may be dependent on the number of bosonic excitations of the physical system represented in the Hamiltonian and whether the hardware of the quantum computer used to execute the quantum circuit has a qubit, qutrit, or qudit architecture. For example, the hardware of the quantum computer system may comprise at least two registers, each register comprising a set of qubits. In some embodiments, the hardware of the quantum computer system comprises two registers, and one register comprises a set of two qubits and the other register comprises a set of four qubits however, alternatively, in some embodiments, the hardware of the quantum computer system comprises two registers, and each register comprises a set of three qubits. The states for the bosonic components may be accordingly mapped to a first set of qubits which is different from a second set of qubits to which the states for the spin components are mapped to. In some embodiments, the quantum computer hardware has a qubit architecture and wherein the mapping comprises a direct one-to-one mapping or a binary mapping of the states to qubits and the spin operators may have a spin of ½+n, where n is an integer of 1 or more to accommodate the number of excitations of the bosonic operators converted into spin operators.

In some embodiments, as the quantum circuit is executed on hardware of the quantum computer, a measurement of a measurable observable is performed at each time-step up to a characteristic time T=1/J, where J is the value of the hopping strength between cavities of the physical system.

In some embodiments, each measurement of a measurable observable is made at time t=m*dt, where dt is a time interval for each trotter step, and m is the number of trotter steps performed.

In some embodiments, compiling the quantum circuit comprises constructing an elementary circuit corresponding to one Trotter step and then appending Nₜᵣₒₜₜₑᵣ*m elementary circuits to one another to form the quantum circuit representing the physical system, where Nₜᵣₒₜₜₑᵣ is the number slices in the unitary matrix, V, representing a Trotter-Suzuki decomposition of the exact unitary matrix, U, which represents the evolution operator for the initial states of the Hamiltonian. In some embodiments, the compiled quantum circuit is then optimized by assuming no device constraints and by performing one or more or all of, and not necessarily in the following order: removing redundancies, applying Clifford gate simplifications, commuting single-qubit gates to the front of the circuit, and performing one or more compiler passes to balance reducing the Trotter error with increasing Nₜᵣₒₜₜₑᵣ slices whilst minimizing the circuit depth.

In some embodiments, the spin components represent two-level systems, and the physical system may be describable by a Hubbard-Jaynes-Cummings (HJC) Hamiltonian.

Alternatively, the Hamiltonian may represents other types of bosonic excitations and/or a physical system comprising electrons in molecules or a similar electronic structure.

For example, tracking the behaviour with time of the physical system comprises determining whether and when QED effects in the physical system represent an occurrence of a quantum phase transition. The quantum phase transition within the physical system may correspond to a transition from a Mott insulator to a superfluid.

Other types of phase transition may also be tracked in some embodiments of the disclosed technology, for example, the disclosed methods may be used to compile quantum circuits which when executed on a quantum computer simulate the behaviour of physical systems comprising ultracold atoms are trapped in optical lattices. Other physical systems whose behaviour may be simulated using the disclosed technology may comprise, but are not limited to, physical systems comprising superconducting circuits, for example, in Josephson junction arrays, physical systems comprising in trapped ion systems, physical systems comprising circuit QED lattices, and physical systems comprising photonic lattices.

In some embodiments where the tracked behaviour comprises a QED phase transition of or in the physical system, a measured observable comprises an overlap parameter. The method of tracking the behaviour of the physical system may then further comprise using the overlap parameter to measure the overlap between an initial state and a time-propagated wave function of the Hamiltonian of the physical system, whereby the phase transition causes the overlap parameter to indicate a minimum overlap.

In some embodiments, for example, where the tracked behaviour comprises a QED phase transition of or in the physical system, a measurable observable may comprise an order parameter. The method may then further comprise using the order parameter to measure the mean variance over time of a polaritonic excitation number, wherein the phase transition separates two regions in which the order parameter plateaus.

In some embodiments where a polatronic mapping is used, however there is no need to separate out the register to map bosons and spins separately.

In some embodiments, a cavity has an initial state comprising a linear combination of Fock states, wherein only one type of excitation is allowed for a Fock state, such that either a spin component in the excited state or a bosonic component is present.

In some embodiments, the full initial state is constructed as a tensor product of L individual cavity states, where L is the number of cavities.

In some embodiments, the physical system comprises more than two cavities.

In some embodiments, the initial state is provided by a particle-preserving ansatz which is mapped to a quantum circuit of the quantum computing system.

In some embodiments, the quantum computing system comprises a native quantum computer. Other embodiments use a quantum computing system which is a hybrid combination of quantum and classical computers. It is also possible for quantum computing simulations to be performed on high-performance classical computers, as an emulation of a quantum computer.

In some embodiments, the physical system is initially represented by a wavefunction corresponding to an Mott insulator, wherein the Hamiltonian represents a phase transition of the physical system to a superfluid, and wherein the measured observables which track over time a QED behaviour of the physical system providing an indication of when the wavefunction corresponds to the physical system being a superfluid. For example, in some embodiments, a Mott insulator-to superfluid phase transition may be characterised by the changing nature of excitations from polaritonic to photonic. The QED behaviour tracked over time of the physical system may comprise photon hopping.

For example, in a physical system comprising a trapped ion architecture, a phase transition can be induced and studied by adjusting trap frequencies, ion spacing, and the intensity and frequency of the applied laser fields. By simulating such a physical system on a quantum computer, the resulting observables may be used to provide an indication of how or which parameters representing the above cause the physical system to behave as the insulator or the superfluid.

The measured observables may represent measurements of at least one of the following: a photon number in each cavity of the physical system, a plurality of atomic state populations of the physical system, an energy spectrum of the physical system, a band structure of the physical system, an excitation transfer within the physical system; and measurements of a quantum state entanglement.

In some embodiments of the disclosed technology, a quantum computing system may be configured to investigate quantum electrodynamic effects in a physical system containing bosonic components and spin components using a Hamiltonian representation which comprises states and operators for the bosonic components and spin components, wherein the physical system comprises a plurality of cavities in which the bosonic and spin components of the physical system are located, wherein the bosonic and spin components of the physical system interact with one another according to quantum electrodynamics and are able to hop between the cavities, where the quantum computing system is configured to map the states and operators from the Hamiltonian representation of the physical system to compile a quantum circuit for execution on the quantum computing system; and execute the quantum circuit on qubits of the quantum computing system to track the behaviour with time of the physical system.

FIG. 13 illustrates schematically an example embodiment of a method 1300 performed by a classical computer system to track a behaviour of a physical system using the disclosed technology and which may in some embodiments be performed as part of the method 900 illustrated in FIG. 10.

The method shown schematically in FIG. 13 may comprise, in some embodiments of the disclosed technology, a method for compiling a quantum circuit for tracking a quantum electrodynamic, QED, behaviour of a mixed-spin physical system, wherein the mixed spin physical system comprises bosonic components and other spin components located in a plurality of cavities, wherein the bosonic and spin components experience QED interactions with each other, and wherein bosonic components of the physical system are able to hop between coupled cavities, the method comprising, in 1330 for example of FIG. 13, mapping states and general spin operators, S, not limited to spin ½, wherein the general spin operators comprise higher spin operators for the bosonic components and operators for the other spin components of the physical system, to hardware of a quantum computing system to compile the quantum circuit.

In some embodiments, the method 1300 for tracking a behaviour with time of a mixed-spin physical system also causes the quantum circuit to be loaded and executed on hardware of the quantum computing system in 1340 for example to obtain measured observables in 1350 for example; and further comprises using the measured observables to track the behaviour with time of the physical system in 1360 for example.

In some embodiments of the method for tracking a quantum electrodynamic behaviour in a physical system using a quantum computing system, the method comprises compiling, at a classical computer system, a quantum circuit for execution on the quantum computing system by: defining a Hamiltonian representation of the physical system in 1310 for example and based on the Hamiltonian representation, defining in 1315 for example states and operators for the bosonic components and spin components, subjecting the operators for the bosonic components to a transformation to transform the bosonic operators into higher-spin operators which map to the multiphoton regime of the physical system in 1320 for example; and mapping, in 1330 for example, the states and operators derived from the Hamiltonian representation of the physical system to hardware of the quantum computing system to compile the quantum circuit for execution on the quantum computing system, and causing, in 1340 for example, the quantum computing system to load the compiled quantum circuit for execution on hardware of the quantum computing system, and execute the quantum circuit on the hardware of the quantum computing system; and obtain measured observables from executing the quantum circuit in 1350 for example. There may be multiple executions (shots) performed to ensure reliability of measurement results.

The quantum computer system accordingly may be used in some embodiments to execute the quantum circuits and measure the results for each time step.

The method 1300 then further comprises: tracking a behaviour, for example a phase transition, with time of the physical system based on the observables measured by the quantum computing system in 1360 for example. In some embodiments of method 1300, the bosonic components of the physical system are subject to an inverse Holstein-Primakoff transformation to transform map the bosonic operators into higher-spin operators. In some embodiments, the physical system is a complex physical system as described herein.

Some embodiments of the disclosed technology comprise a quantum computer system 250 configured to measure observables for tracking a behaviour with time of a physical system when executing a quantum circuit compiled by a classical computer system according to an embodiment of the disclosed technology.

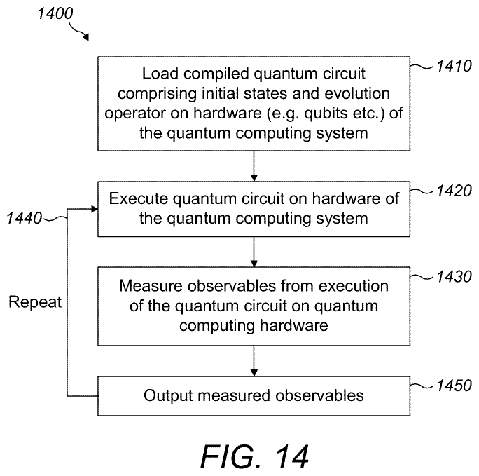

FIG. 14 illustrates schematically an example embodiment of a method for providing measurements of observables obtained by executing a quantum circuit on such a quantum computer in order to track a behaviour with time of a physical system according to the disclosed technology.

In some embodiments of the disclosed technology one or more steps of the method illustrated in FIG. 14 are performed by a quantum computer system configured to provide measurements of observables generated when executing a quantum circuit for tracking a behaviour with time of a physical system.

In some embodiments, the method 1400 comprises: loading, in 1410 for example, a complied quantum circuit comprising initial states and an evolution operator for execution on hardware of the quantum computer system, executing, in 1420 for example, the compiled quantum circuit to measure observables in 1430 for example, and outputting in 1450 for example, measurements of observables obtained from executing the quantum circuit. The quantum circuit may be executed multiple times, such that, for example, 1420 t 1430 are repeated at least once, see 1440 for example in FIG. 14, in other words, a number of shots may be taken using the quantum computer. The output in 1450 may comprise multiple measurements of observables which may be post-processed by a classical computer system in some embodiments.

In some embodiments, the output is provided to directly or indirectly to a classical computer system on which the quantum circuit was compiled for execution by the quantum computer.

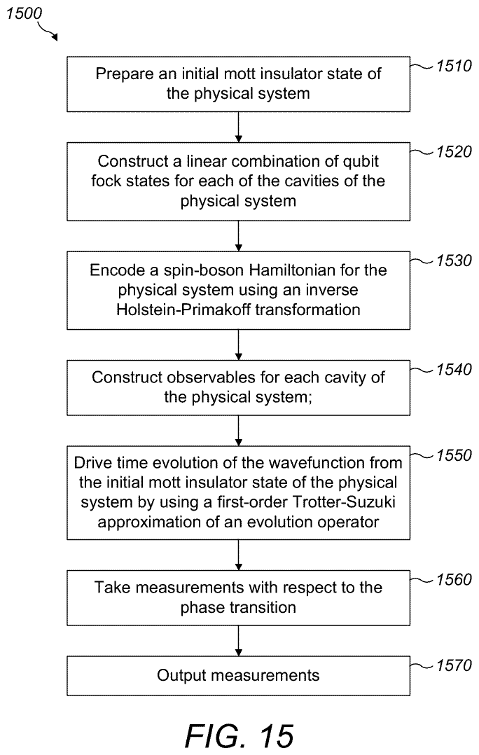

FIG. 15 illustrates schematically an example embodiment of a method for simulating a phase transition of a physical system from a Mott insulator to a superfluid on a quantum computer. Some examples of the method illustrated in FIG. 15 comprise a method for simulating a phase transition in a physical system from a Mott insulator to a superfluid on a quantum computer where the method comprises: preparing in 1510 for example an initial Mott insulator state of the physical system by, for example, constructing a linear combination of qubit Fock states for each cavity of a plurality of cavities of the physical system, encoding a spin-boson Hamiltonian for the physical system using an inverse Holstein-Primakoff transformation in 1530 for example, constructing observables for each cavity of the physical system in 1540 for example, driving time evolution of the wavefunction from the initial Mott insulator state of the physical system by using a first-order Trotter-Suzuki approximation of an evolution operator; and taking measurements with respect to the phase transition in 1560 for example. The measurements are provided as output in 1570, for example, for post-processing by a classical computer which may be the same computer as that which was used to compile the quantum circuit or a different one.

In some embodiments, the qubit Fock states are constructed using a Givens rotations ansatz.

In some embodiments, the observables constructed for each cavity of the physical system comprise one or more or all of: an overlap squared parameter, a Lambda-parameter related to the overlap squared parameter, a polaritonic excitations number operator, and a variance of the polaritonic excitations number operator.

In some embodiments, the method further comprises using a strong-coupling regime to allow using big Trotter steps such that one time step equals the Trotter step.

In some embodiments, the physical system comprises a plurality of bosonic components and other spin components located in cavities, wherein the bosonic components and other spin components have quantum electrodynamic interactions with each other and wherein the bosonic components may hop from one coupled cavity to another cavity.

In some embodiments, the physical configuration of the physical system comprises multiple cavities having an identical nature to one another, wherein any measurements of the order parameter are performed for only one of the cavities.

Based on the disclosed technology, quantum circuits which are recompiled with bosonic excitations mapped using the inverse Holstein-Primakoff transformation may result in complied quantum circuits with reduced circuit depths when executed on either an ion trap or a superconducting quantum computing hardware architecture. In embodiments where a quantum computer system has a qudit-based architecture, recompiling using the inverse Holstein-Primakoff mapping could potentially lead to shorter quantum circuits.

A technical benefit of the disclosed technology for mixed-spin physical systems such as those disclosed herein as complex physical systems comprising bosonic components and spin components located in cavities, where the bosonic components and spin components undergo QED interactions with each other and where the bosonic components may be able to hop from cavity to cavity, is that the quantum circuit based on higher-spin operators for the bosonic components of in the Hamiltonian evolution operator may be complied for execution on a quantum computer comprising fewer qubits than would be required if the bosonic component operators were not transformed to higher-spin operators. This may allow simulations of such complex physical systems to be run on quantum computers with fewer quantum logical gates than might be required if the pre-compiling transformation of the Hamiltonian operators for the bosonic components was not performed as part of defining the Hamiltonian evolution operator.

The disclosed technology assumes that the noise level of the quantum hardware of any physical quantum computing system is acceptable. Any damping or dissipation effects which are present in a physical quantum computing system may, at least in principle, be modelled in some embodiments as noise and managed accordingly using a suitable technique such as may be known to someone of ordinary skill in the art.

In conclusion, while various implementations and examples have been described herein, they are provided by way of illustration, and many potential modifications will be apparent to the skilled person having regard to the specifics of any given implementation. Accordingly, the scope of the present case should be determined from the appended claims.

### REFERENCES

[1] Joaqu'in Figueroa, Jos′e Rogan, Juan Alejandro Valdivia, Miguel Kiwi, Guillermo Romero, and Felipe
Torres. Nucleation of superfluid-light domains in a quenched dynamics. Scientific Reports, 8(1):1-7, 2018. URL https://www.nature.com/articles/s41598-018-30789-9.
[2] David Zueco. Light-matter interaction in the nonperturbative regime: a lecture. Rev. Real Academia de Ciencias. Zaragoza., 74:41-74, 2019. URL http://www.raczar.es/webracz/ImageServlet? mod=publicaciones&subMod=revistas&car=revista74&archivo-041_Zueco.pdf.
[3] Jorge Calvo Ibar, Zueco Lainez, and David Mart'in Moreno. Dynamics and spectrum of a molecule coupled to a vibrational mode. 2021. URL https://digital.csic.es/handle/10261/270188.
[4] Andreas Burger, Leong Chuan Kwek, and Dario Poletti. Digital Quantum Simulation of the Spin-Boson Model under Markovian Open-System Dynamics. Entropy, 24:1766, 2022. URL https://www.mdpi.com/1099-4300/24/12/1766.
[5] Kade Head-Marsden, Stefan Krastanov, David A. Mazziotti, and Prineha Narang. Capturing nonmarkovian dynamics on near-term quantum computers. Phys. Rev. Res., 3:013182, February 2021. URL https://link.aps.org/doi/10.1103/PhysRevResearch.3.013182.
[6] Weitang Li, Jiajun Ren, Sainan Huai, Tianqi Cai, Zhigang Shuai, and Shengyu Zhang. Efficient quantum simulation of electron-phonon systems by variational basis state encoder. Phys. Rev. Research, 5:023046, 2023. URL https://journals.aps.org/prresearch/abstract/10.1103/PhysRevResearch.5.023046.
[7] Nicolas P. D. Sawaya, Tim Menke, Thi Ha Kyaw, Sonika Johri, Al'an Aspuru-Guzik, and Gian Giacomo Guerreschi. Resource-efficient digital quantum simulation of d-level systems for photonic, vibrational, and spin-s hamiltonians. npj Quantum Information, 6:49, 2020. URL https://www.nature.com/articles/s41534-020-0278-0.
[8] Marco Majland and Nikolaj Thomas Zinner. Resource-efficient encoding algorithm for variational bosonic quantum simulations. arXiv.org, 2021. URL https://arxiv.org/abs/2102.11886.
[9] Yulun Wang and Predrag S. Krstic. Multistate transition dynamics by strong time-dependent perturbation in NISQ era. arXiv.org, 2022. URL https://arxiv.org/abs/2112.06365.
[10] Joonsuk Huh Seungbeom Chin, Jaehee Kim. Quantum circuit simulation of linear optics using fermion to qubit encoding. arXiv.org. URL https://arxiv.org/abs/2209.00207.
[11] Nicolas P. D. Sawaya, Francesco Paesani, and Daniel P. Tabor. Near- and long-term quantum algorithmic approaches for vibrational spectroscopy. Phys. Rev. A, 104:062419, 2021. URL https://link.aps.org/doi/10.1103/PhysRevA.104.062419.
Benjamin Jaderberg, Alexander Eisfeld, Dieter Jaksch, Sarah Mostame. Recompilation-enhanced simulation of electron-phonon dynamics on ibm quantum computers. New Journal of Physics, 24 (9):093017, 2022. URL https://iopscience.iop.org/article/10.1088/1367-2630/ac8a69.
[13] Bo Peng, Yuan Su, Daniel Claudino, Karol Kowalski, Guang Hao Low, and Martin Roetteler. Quantum simulation of boson-related hamiltonians: Techniques, effective hamiltonian construction, and error analysis. arXiv, 2023. URL https://arxiv.org/abs/2307.06580.
[14] Alexander Miessen, Pauline J. Ollitrault, and Ivano Tavernelli. Quantum algorithms for quantum dynamics: A performance study on the spin-boson model. Phys. Rev. Res., 3:043212, December 2021. URL https://link.aps.org/doi/10.1103/PhysRevResearch.3.043212.
[15] Nathan Fitzpatrick, Harriet Apel, and David Mu\tilde{ } noz Ramo. Evaluating low-depth quantum algorithms for time evolution on fermion-boson systems. arXiv.org, 2021. URL http://arxiv.org/abs/2106.03985.
[16] Seyon Sivarajah, Silas Dilkes, Alexander Cowtan, Will Simmons, Alec Edgington, and Ross Duncan. tket [symbol] : a retargetable compiler for NISQ devices. Quantum Science and Technology, 6(1):014003, 2020. URL https://iopscience.iop.org/article/10.1088/2058-9565/ab8e92.
[17] Seungbeom Chin, Jaehee Kim, and Joonsuk Huh. Digital quantum simulation of boson systems with Jordan-Wigner transformation: Generating Hong-Ou-Mandel dip in quantum computers. arXiv.org, 2022. URL http://arxiv.org/abs/2209.00207.
[18] Sam Morley-Short Sam. Advanced Quantum Information Theory Essay. Simulating Chemistry on Quantum Computers: From atoms to algorithms-a holistic review. 2015. URL https://research-information.bris.ac.uk/en/publications/simulating-chemistry-on-quantum-computers-from-atoms-to-algorithm.
[19] Xin-Yu Huang, Lang Yu, Xu Lu, Yin Yang, De-Sheng Li, Chun-Wang Wu, Wei Wu, and Ping-Xing Chen. Qubitization of Bosons. arXiv.org, 2021. URL http://arxiv.org/abs/2105.12563.
[20] Theodore Holstein and Henry Primakoff. Field dependence of the intrinsic domain magnetization of a ferromagnet. Phys. Rev., 58:1098-1113, 1940. URL https://link.aps.org/doi/10.1103/PhysRev.58.1098.
[21] X. Huang, T. Kosugi, H. Nishi, and Y.-i. Matsushita, Optimized synthesis of circuits for diagonal unitary matrices with reflection symmetry, arXiv.org (2023).
[22] C. S″ underhauf, E. Campbell, and J. Camps, Blockencoding structured matrices for data input in quantum computing, Quantum 8, 1226 (2024).
[23] Carla Maria Pontes Carneiro and Giancarlo Queiroz Pellegrino. Inverse holstein-primakoff transformation of bosonic operators—application to a bilayer model. Europhysics Letters, 141(5):50002, 2023. URL https://dx.doi.org/10.1209/0295-5075/acbed8.
[24] Jurgen Konig and Alfred Hucht. Newton series expansion of bosonic operator functions. SciPost Physics, 10(1):1-18, 2021. URL https://scipost.org/SciPostPhys.10.1.007/pdf.
[25] Jonathan Welch, Daniel Greenbaum, Sarah Mostame, and Alan Aspuru-Guzik. Efficient quantum circuits for diagonal unitaries without ancillas. New Journal of Physics, 16(3):033040, 2014. URL https://dx.doi.org/10.1088/1367-2630/16/3/033040.
[26] Ariel Norambuena, Diego Tancara, and Ra'ul Coto. Coding closed and open quantum systems in MATLAB: Applications in quantum optics and condensed matter. arXiv.org, 41(4), 2020. URL https://iopscience.iop.org/article/10.1088/1361-6404/ab8360.
[27] Robert R. Tucci. A rudimentary quantum compiler, 1998. URL https://arxiv.org/abs/quant-ph/9805015.
[28] Vivek V. Shende, Stephen S. Bullock, and Igor L. Markov. Recognizing small-circuit structure in twoqubit operators. Physical Review A, 70(1), 2004. URL https://doi.org/10.1103% 2Fphysreva. 70.012310.
[29] Vivek V. Shende, Stephen S. Bullock, and Igor L. Markov. Synthesis of quantum-logic circuits. IEEE Transactions on Computer-Aided Design of Integrated Circuits and Systems, 25(6):1000-1010, 2006. URL https://doi.org/10.1109% 2Ftcad.2005.855930.
[30] Robert R. Tucci. An Introduction to Cartan's KAK Decomposition for QC Programmers. arXiv.org, 2005. URL https://arxiv.org/abs/quant-ph/0507171.
[31] Sigurdur Helgason. Differential Geometry, Lie Groups, and Symmetric Spaces. Am. Math. Soc., 2001. URL https://math.mit.edu/˜helgason/lie_groups_24-1.pdf.
[32] Navin Khaneja and Steffen J. Glaser. Cartan decomposition of SU(2n) and control of spin systems. Chemical Physics, 267(1):11-23, 2001. URL https://www.sciencedirect.com/science/article/pii/S0301010401003184.
[33] Matthew P. A. Fisher, Peter B. Weichman, G. Grinstein, and Daniel S. Fisher. Boson localization and the superfluid-insulator transition. Phys. Rev. B, 40:546-570, July 1989. doi: 10.1103/PhysRevB. 40.546. URL https://link.aps.org/doi/10.1103/PhysRevB.40.546.
[34] Markus Greiner, Olaf Mandel, Tilman Esslinger, Theodor W. Hansch, and Immanuel Bloch. Quantum phase transition from a superfluid to a mott insulator in a gas of ultracold atoms. Nature, 415(6867):39-44, 2002. URL https://doi.org/10.1038/415039a.
[35] Andrew A. Houck, Hakan E. T'ureci, and Jens Koch. On-chip quantum simulation with superconducting circuits. Nature Physics, 8(4):292-299, 2012. URL https://doi.org/10.1038/nphys2251.
[36] Juan Miguel Arrazola, Olivia Di Matteo, Nicola s Quesada, Soran Jahangiri, Alain Delgado, and Nathan Killoran. Universal quantum circuits for quantum chemistry. Quantum, 6:742, 2022. URL https://quantum-journal.org/papers/q-2022-06-20-742/.
[37] Adriano Barenco, Andre Berthiaume, David Deutsch, Artur Ekert, Richard Jozsa, and Chiara Macchiavello. Stabilization of quantum computations by symmetrization. SIAM Journal on Computing, 26(5):1541-1557, 1997. URL https://epubs.siam.org/doi/10.1137/S0097539796302452.
[38] Joonho Lee, William J. Huggins, Martin Head-Gordon, and K. Birgitta Whaley. Generalized unitary coupled cluster wave functions for quantum computation. Journal of Chemical Theory and Computation, 15(1):311-324, 2018. URL https://pubs.acs.org/doi/10.1021/acs.jctc.8b01004.
[39] Qiskit contributors. Qiskit: An open-source framework for quantum computing. 2023. doi: 10. 5281/zenodo.2573505. URL https://github.com/Qiskit.
[40] Earl Campbell. Random Compiler for Fast Hamiltonian Simulation. Physical Review Letters, 123(7):1-11, 2019. URL https://journals.aps.org/prl/abstract/10.1103/PhysRevLett.123. 070503.
[41] G. H. Low and I. L. Chuang, Hamiltonian Simulation by Qubitization, Quantum 3, 163 (2019).
[42] Hsin-Yuan Huang, Richard Kueng, and John Preskill. Predicting many properties of a quantum system from very few measurements. Nature Physics, 16(10):1050-1057, 2020. URL https://www. nature.com/articles/s41567-020-0932-7.

1. A method for tracking over time quantum electrodynamic, QED, effects in a physical system containing bosonic components and other spin components using a quantum computing system, the method comprising:
defining a Hamiltonian representation of the physical system, wherein the Hamiltonian representation comprises states and operators for the bosonic components and other spin components, wherein the physical system comprises a plurality of cavities in which the bosonic and other spin components of the physical system are located, wherein the bosonic and other spin components of the physical system interact with one another according to quantum electrodynamics, and wherein the bosonic components of the physical system are able to hop between the cavities;
mapping the states and operators from the Hamiltonian representation of the physical system to prepare a quantum circuit that simulates the physical system, and compiling the quantum circuit for execution on the quantum computing system;
executing the quantum circuit on hardware of the quantum computing system to measure observables; and
using the measured observables to track a QED behaviour with time of the physical system.

2. The method of claim 1, wherein the boson operators are expressed in terms of higher-spin operators, and the mapping uses the higher-spin operators for the bosonic components and the spin operators for the other spin components to compile the quantum circuit for execution on the quantum computer.

3. The method of claim 2, wherein the method further comprises obtaining higher-order operators for the bosonic components by subjecting bosonic operators in the Hamiltonian to a transformation.

4. The method of claim 3, wherein the transformation comprises an inverse Holstein-Primakoff transformation.

5. The method of claim 4, wherein physical system comprises a multiphoton regime and the operators for the bosonic components in the Hamiltonian are transformed using the inverse Holstein-Primakoff transformation into higher-spin operators which are mapped with the spin operators for the other spin components to a quantum circuit for simulating the multiphoton regime when executed on the quantum computer.

6. The method of claim 4, wherein the method comprises:
compiling the quantum circuit by expressing the bosonic components of the Hamilton as higher-order spin operators using an inverse Holstein-Primakoff transformation;
finding qubit representations separately for an inverse square root operator and spin ladder operators of the Hamiltonian;
exponentiating the qubit representations for the operators using the operator Trotter-Suzuki decomposition; and
optimizing circuit for a backend system.

7. The method of claim 1, wherein a classical computer system is used to prepare and compile the quantum circuit for execution by the quantum computing system by performing the steps:
defining the Hamiltonian representation of the physical system; and
mapping the states and operators from the Hamiltonian representation of the physical system to prepare and compile the quantum circuit simulating the physical system; and
wherein the method further comprises the classical computer causing the quantum computer system to:
load the compiled quantum circuit on the quantum computer hardware;
execute the quantum circuit to measure the observables; and
provide the measured observables to the or another classical computer system for tracking the QED behaviour over time of the physical system.

8. The method of claim 1, wherein the compiled quantum circuit comprises initial states for the bosonic and other spin operators of the physical system and an evolution operator for the initial states derived from the Hamiltonian and one or more measurement circuits for measuring observables as the quantum circuit is executed on the hardware of the quantum computing system.

9. The method of claim 1, wherein the mapping is dependent on the number of bosonic excitations of the physical system represented in the Hamiltonian and whether the hardware of the quantum computer used to execute the quantum circuit has a qubit, qutrit, or qudit architecture.

10. The method of claim 1, wherein the hardware of the quantum computer system comprises at least two registers, each register comprising a set of qubits, wherein the states for the bosonic components are mapped to a first set of qubits and the states for the spin components are mapped to a second set of qubits distinct from the first set of qubits.

11. (canceled)

12. The method of claim 1, wherein as the quantum circuit is executed on hardware of the quantum computer, a measurement of a measurable observable is performed at each time-step up to a characteristic time T=1/J, where J is the value of the hopping strength between cavities of the physical system.

13. The method of claim 12, wherein each measurement of a measurable observable is made at time t=m*dt, where dt is a time interval for each trotter step, and m is the number of time steps performed, and wherein compiling the quantum circuit comprises:
constructing an elementary circuit corresponding to one Trotter step; and
appending [symbol] N [symbol] _trotter*m elementary circuits to one another to form the quantum circuit representing the physical system, where Ntrotter is the number slices in the unitary matrix, V, representing a Trotter-Suzuki decomposition of the exact unitary matrix, U, which represents the evolution operator for the initial states of the Hamiltonian.

14. (canceled)

15. The method of claim 13, further comprising:
optimizing the compiled quantum circuit, by assuming no device constraints and by:
removing redundancies;
applying Clifford simplifications;
commuting single-qubit gates to the front of the circuit; and
performing one or more compiler passes to balance reducing the Trotter error with increasing N_trotter slices whilst minimizing the circuit depth.

16-23. (canceled)

24. The method of claim 1, wherein tracking the behaviour with time of the physical system determines whether and when a quantum phase transition occurs.

25. The method of claim 24, wherein the quantum phase transition within the physical system corresponds to a transition from a Mott insulator to a superfluid.

26. The method of claim 24, wherein a measured observable comprises an overlap parameter, wherein the method further comprises using the overlap parameter to measure the overlap between an initial state and a time-propagated wave function, whereby a phase transition causes the overlap parameter to indicate a minimum overlap.

27. The method of claim 24, wherein a measured observable comprises an order parameter, wherein the method further comprises using an order parameter to measure the mean variance over time of a polaritonic excitation number, wherein the phase transition separates two regions in which the order parameter plateaus.

28. The method of claim 1, wherein a cavity has an initial state comprising a linear combination of Fock states, wherein only one type of excitation is allowed for a Fock state, such that either a spin component in the excited state or a bosonic component is present.

29. The method of claim 1, wherein the full initial state is constructed as a tensor product of L individual cavity states, where L is the number of cavities.

30. The method of claim 1, wherein the initial state is provided by a particle-preserving ansatz which can be implemented using a quantum circuit of the quantum computing system.

31. The method of claim 1, wherein the physical system is initially represented by a wavefunction corresponding to an Mott insulator, wherein the states and operators of the Hamiltonian representation of the physical system represent dynamic behaviour of the physical system including a phase transition to a superfluid, and wherein the measured observables which track over time a QED behaviour of the physical system provide an indication of when the wavefunction corresponds to the physical system being a superfluid.

32. The method of claim 1, wherein the QED behaviour tracked over time of the physical system comprises photon hopping.

33. The method of claim 1, wherein the measured observables represent measurements of at least one of the following:
photon number in each cavity of the physical system;
a plurality of atomic state populations of the physical system;
an energy spectrum of the physical system;
a band structure of the physical system;
an excitation transfer within the physical system; and
measurements of the quantum state entanglement.

34. A quantum computing system configured to investigate quantum electrodynamic effects in a physical system containing bosonic components and spin components using a Hamiltonian representation which comprises states and operators for the bosonic components and spin components, wherein the physical system comprises a plurality of cavities in which the bosonic and spin components of the physical system are located, wherein the bosonic and spin components of the physical system interact with one another according to quantum electrodynamics and are able to hop between the cavities, wherein the quantum computing system is configured:
to map the states and operators from the Hamiltonian representation of the physical system to compile a quantum circuit for execution on the quantum computing system; and
to execute the quantum circuit on qubits of the quantum computing system to track the behaviour with time of the physical system.

35-36. (canceled)

37. A method for tracking a quantum electrodynamic behaviour in a physical system using a quantum computing system, wherein the method comprises:
compiling, at a classical computer system, a quantum circuit for execution on the quantum computing system by:
defining a Hamiltonian representation of the physical system, wherein the Hamiltonian representation comprises states and operators for the bosonic components and spin components,
subjecting the operators for the bosonic components to a transformation to transform the bosonic operators into higher-spin operators which map to the multiphoton regime of the physical system; and
mapping the states and operators from the Hamiltonian representation of the physical system to hardware of the quantum computing system to compile the quantum circuit for execution on the quantum computing system; and
causing the quantum computing system to:
load the compiled quantum circuit for execution on hardware of the quantum computing system;
execute the quantum circuit on the hardware of the quantum computing system; and
obtain measured observables from executing the quantum circuit,
wherein the method further comprises:
tracking a behaviour with time of the physical system based on the observables measured by the quantum computing system.

38. The method of claim 37, wherein the bosonic components of the physical system are subject to an inverse Holstein-Primakoff transformation to transform map the bosonic operators into higher-spin operators.

39. A quantum computer system configured to measure observables for tracking a behaviour with time of a physical system when executing a quantum circuit compiled by a classical computer system according to claim 37.

40-44. (canceled)

45. A quantum computer system configured to measure observables for tracking a behaviour with time of a physical system when executing a quantum circuit compiled by a classical computer system according to claim 38.
